(19) United States
(12) Patent Application Publication
(10) Pub. No.: US 2025/0081125 A1
(43) Pub. Date: Mar. 6, 2025

(54) COMMUNICATION METHOD AND APPARATUS, STORAGE MEDIUM, AND PROGRAM PRODUCT

(71) Applicant: Xi'an Unisoc Technologies Co., Ltd., Xi'an, Shaanxi (CN)

(72) Inventors: Haowen LIU, Xi 'an (CN); Mimi CHEN, Xi'an (CN); Meng ZHANG, Xi'an (CN)

(73) Assignee: Xi'an Unisoc Technologies Co., Ltd., Xi'an, Shaanxi, CN (CN)

(21) Appl. No.: 18/535,309

(22) PCT Filed: Jan. 5, 2023
(86) PCT No.: PCT/CN2023/070646

§ 371 Date: Dec. 11, 2023

(30) Foreign Application Priority Data
Jan. 21, 2022 (CN) 2022100738299

(51) Int. Cl. H04W 52/36; H04W 28/06; H04W 52/28; H04W 52/42

(52) U.S. Cl. CPC H04W 52/367; H04W 28/06; H04W 52/28; H04W 52/42

(57) ABSTRACT

A communication method including: when a sum of transmission powers of N carriers is greater than a maximum transmission power P, adjusting a transmission powers sequentially based on a priority order from low to high of services to be transmitted on the N carriers, until a sum of transmission powers of the N carriers after adjustment is less than or equal to P, where carriers, out of the N carriers, for corresponding services having a same priority are subjected to transmission power adjustment based on a first adjustment order; some or all of the N carriers are used for communication with a second terminal device; and performing, with use of adjusted respective transmission powers of M carriers, channel/signal transmission on the M carriers simultaneously, where the M carriers are carriers, subjected to transmission power adjustment out of the N carriers, with transmission powers not being 0.

### CROSS-REFERENCE TO RELATED APPLICATIONS

This application is a National Stage of International Application No. PCT/CN2023/070646, filed on Jan. 5, 2023, which claims priority to Chinese Patent Application No. 202210073829.9, filed on Jan. 21, 2022, both of the applications are hereby incorporated by reference in its entirety.

### TECHNICAL FIELD

The present disclosure relates to the field of communication technologies and, in particular, to a communication method and apparatus, a storage medium, and a program product.

### BACKGROUND

In a 5th generation mobile communication system (5th generation wireless system, 5G) vehicle-to-everything (Vehicle-to-Everything, V2X) network, a terminal device can use multiple carriers simultaneously for channel/signal transmission, where the multiple carriers may all be used for channel/signal transmission to another terminal device, or some of the carriers are used for channel/signal transmission to another terminal device and some of the carriers are used for channel/signal transmission to a network device.

### SUMMARY

In a first aspect, the present disclosure provides a communication method, being applied to a first terminal device, where the method includes:
when a sum of transmission powers of N carriers is greater than a maximum transmission power of the first terminal device, adjusting a transmission power sequentially based on a priority order from low to high of services to be transmitted on the N carriers, until a sum of transmission powers of the N carriers after adjustment is less than or equal to the maximum transmission power, where carriers, out of the N carriers, for corresponding services having a same priority are subjected to transmission power adjustment based on a first adjustment order, the first adjustment order is related to a type of a channel/signal to be transmitted on the carriers for the corresponding services having the same priority; some or all of the N carriers are used for communication with a second terminal device; and N is an integer greater than or equal to 2; and
performing, with use of adjusted respective transmission powers of M carriers, channel/signal transmission on the M carriers simultaneously, where the M carriers are carriers, subjected to transmission power adjustment out of the N carriers, with transmission powers not being 0, and M is an integer greater than 0 and less than or equal to N.

In a second aspect, the present application provides a communication apparatus, including: a processor and a memory;

where the memory is configured to store computer executable program codes including instructions; and when the processor executes the instructions, the instructions enable the communication apparatus to implement the method according to any item of the first aspect.

In a third aspect, the present application provides a computer readable storage medium, storing thereon a computer program, where the computer program is configured to, when being executed by a computer, implement the communication method according to any item of the first aspect.

### BRIEF DESCRIPTION OF DRAWINGS

FIG. 1 is a schematic structural diagram of a communication system to which an embodiment of the present disclosure is applied.

FIG. 2 is a schematic flowchart of a communication method according to an embodiment of the present disclosure.

FIG. 3 is another schematic flowchart of a communication method according to an embodiment of the present disclosure.

FIG. 4 is yet another schematic flowchart of a communication method according to an embodiment of the present disclosure.

FIG. 5 is a schematic structural diagram of a communication apparatus according to an embodiment of the present disclosure.

FIG. 6 is another schematic structural diagram of a communication apparatus according to an embodiment of the present disclosure.

FIG. 7 is yet another schematic structural diagram of a communication apparatus according to an embodiment of the present disclosure.

FIG. 8 is still another schematic structural diagram of a communication apparatus according to an embodiment of the present disclosure.

### DESCRIPTION OF EMBODIMENTS

For ease of understanding the solutions according to the embodiments of the present disclosure, the following will firstly specify and explain several technical terms related to the embodiments of the present disclosure.

Maximum transmission power of a carrier: a maximum transmission power allocated to a certain carrier before transmission power adjustment.

Transmission power of a carrier: namely, an actual transmission power of the carrier. The transmission power of the carrier is greater than or equal to 0, and less than or equal to the maximum transmission power of the carrier. It should be understood that the actual transmission power of the carrier is an actual transmission power after a terminal device performs transmission power control, and an initial value of the actual transmission power of the carrier is usually equal to the maximum transmission power of the carrier by default.

Maximum transmission power of a terminal device: namely, a maximum transmission power supported by the terminal device. The terminal device, when using multiple carriers simultaneously for channel/signal transmission, needs to guarantee that a sum of transmission powers of all concurrent carriers is less than or equal to the maximum transmission power of the terminal device.

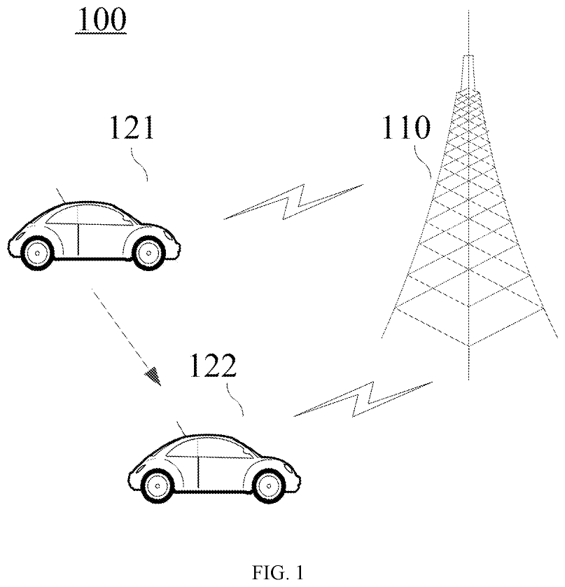

FIG. 1 is a schematic structural diagram of a communication system applicable an embodiment of the present disclosure. As shown in FIG. 1, the communication system 100 may include a network device 110 and a plurality of terminal devices (for example, as shown in FIG. 1, a terminal device 121 and a terminal device 122). The terminal device is connected to the network device in a wireless manner. The terminal device can be stationary, or can be mobile. FIG. 1 is only a schematic diagram, and the communication system may further include other network devices, such as a wireless relay device and a wireless backhaul device, which are not shown in FIG. 1. The network device and the terminal devices included in the communication system are not limited in number in the embodiments of the present disclosure. FIG. 1 is a schematic diagram of an example where there is one network device and two terminal devices.

It should be understood that a specific form of the terminal devices is not limited in the embodiments of the present disclosure.

The terminal device may also be referred to as a user equipment (User Equipment, UE), an access terminal, a subscriber unit, a subscriber station, a mobile station, a mobile platform, a remote station, a remote terminal, a mobile device, a user terminal, a terminal, a wireless communication device, a user proxy or a user apparatus, etc. The terminal device can be a mobile phone (mobile phone), a tablet computer (Pad), a computer with a wireless transceiving function, a virtual reality (virtual reality, VR) terminal device, an augmented reality (augmented reality, AR) terminal device, a wireless terminal device in self driving (self driving), a wireless terminal device in transportation safety (transportation safety), a wireless terminal device in a smart city (smart city), a vehicle-mounted device, a wearable device, a road side unit (Road Side Unit, RSU), a terminal device in a next generation communication system such as an NR network, or a terminal device in a future evolving public land mobile network (public land mobile network, PLMN).

As an example but not a limitation, in the embodiments of the present disclosure, the terminal device can also be a wearable device. The wearable device, which may also be referred to as a wearable smart device, is a generic term for wearable devices such as glasses, gloves, watches, clothes and adornments, and shoes, which are developed from wearable items in daily life by intelligent design with wearable technologies. The wearable device is namely a portable device which is directly wearable or integrated into clothes or adornments of a user. The wearable device is not only just a kind of hardware device, but also more of powerful functionalities implemented with software supports, dada exchanging, and cloud interactions. A wearable smart device in a broad sense includes, for example, a smart watch, smart glasses or the like, which have full functionality and large size and perform complete or partial functionality independently of a smart phone, and may also include, for example, smart bracelets of various types, smart jewelries or the like for physical signs monitoring, which focus on a certain type of application function and need to be used in cooperation with other devices, such as a smart phone.

In the embodiments of the present disclosure, the network device is an access device through which the terminal device wirelessly accesses to the mobile communication system, which can be an evolutional node B (evolutional node B, eNB or eNodeB), a base station in a 5G mobile communication system or a new radio (new radio NR) communication system (for example, a gNB or ng-eNB), a base station in a future mobile communication system, an access node in a wireless fidelity (wireless fidelity, WiFi) system, a relay station etc. The specific technologies and specific device forms that the network device adopts are not limited in the embodiments of the present disclosure. In the embodiments of the present disclosure, the network device may also be referred to as an access network device or a wireless access network device, which is not limited in this regard. In addition, in the embodiments of the present disclosure, the terms 5G and NR can be equivalent.

As an example but not a limitation, in the embodiments of the present disclosure, the network device can have mobility, for example, the network device may be a device this is mobile. In some embodiments, the network device can be a satellite or a balloon station. For example, the satellite can be a low earth orbit (low earth orbit, LEO) satellite, a medium earth orbit (medium earth orbit, MEO) satellite, a geostationary earth orbit (geostationary earth orbit, GEO) satellite, a high elliptic orbit (High Elliptic Orbit, HEO) satellite, etc.

The method provided in the embodiments of the present disclosure can be applied to a V2X communication scenario, or it can also be applied to other similar scenarios. The V2X communication mentioned here can include vehicle-to-vehicle (Vehicle-to-Vehicle, V2V), vehicle-to-infrastructure (Vehicle-to-Infrastructure, V2I), vehicle to people (Vehicle to People, V2P), and vehicle-to-application-server (Vehicle-to-Network, V2N) communication, etc. FIG. 1 is a schematic diagram taking V2V as an example.

Take the terminal device 121 and the terminal device 122 as an example, in the V2X network, a network device can communicate respectively with the terminal device 121 and the terminal device 122 through a wireless air interface, and communication between the terminal device 121 and the terminal device 122 can be conducted through wireless communication technology for vehicles. That is, communication between the terminal device 121 and the terminal device 122 is performed through a side link (Sidelink, SL), and communication between the terminal devices and the network device (i.e., between the network device and the terminal device 121, as well as between the network device and the terminal device 122) is performed through an uplink (uplink) and a downlink (downlink). The side link can also be referred to as a secondary link.

It should be understood that FIG. 1 is merely an example, showing a scenario where the terminal device 121 transmits a channel/signal to the terminal device 122, which should not constitute a limitation to the embodiments of the present disclosure. The terminal device 121 can also receive a channel/signal transmitted by the terminal device 122, which is not limited in the embodiments of the present disclosure in this regard.

In the embodiments of the present disclosure, for the communication in the V2X network, an unlicensed spectrum or a licensed spectrum may be used, or both the unlicensed spectrum and the licensed spectrum may be used for the communication. Among them, the unlicensed spectrum may also be considered as a shared spectrum or a license-free spectrum, and the licensed spectrum may also be considered as an unshared spectrum.

Further reference is made to FIG. 1, take an example where the communication 100 is an NR system, the following technologies may be applied in NR V2X:

Technology 1, carrier aggregation (carrier aggregation, CA) technology is supported in a side link. Namely, CA technology may be applied between terminal devices to perform communication using multiple carriers simultaneously. By introducing the CA technology, terminal devices can obtain a larger service bandwidth and a higher transmission rate.

Technology 2, a feedback mechanism is introduced in unicast and multicast, namely, the hybrid automatic repeat request (Hybrid Automatic Repeat Request, HARQ) feedback mechanism. By introducing the HARQ mechanism, reliability of side link communication can be improved.

Take the terminal device 121 as an example, by introducing the CA technology, the terminal device 121 can simultaneously use multiple carriers for channel/signal transmission. Take N carriers as an example, namely, the terminal device 121 can use N carriers for channel/signal transmission. The N carriers may all be used for channel/signal transmission to the terminal device 122; or some of the carriers are used for channel/signal transmission to the terminal device 122, and some of the carriers are used for channel/signal transmission to the network device, where N is an integer greater than or equal to 2. It should be understood that when the terminal device 121 uses multiple carriers in the N carriers simultaneously for channel/signal transmission to the terminal device 122, it can use the multiple carriers in a CA manner for channel/signal transmission to the terminal device 122.

When the terminal device 121 uses the N carriers simultaneously for channel/signal transmission, due to a limitation of a maximum transmission power of the terminal device 121, it is likely for occurrence of such a situation that a sum of transmission powers of the N carriers is greater than the maximum transmission power P of the terminal device 121, resulting in the inability to use the N carriers for channel/signal transmission. Regarding this situation, the terminal device 121 can perform transmission power control on the N carriers to adjust the transmission power of at least some of the carriers, such that the sum of the transmission powers of the N carriers after adjustment is less than or equal to P. However, how to perform transmission power control on the N carriers is an urgent problem to be addressed.

It should be noted that the transmission powers of the N carriers mentioned above may also be referred to as carrier transmission powers of the N carriers, and the two concepts can be equivalent in the embodiments of the present disclosure.

Still, take the N carriers as an example, currently in LTE V2X CA, the following method is adopted by a terminal device for transmission power control:
step a) selecting, from the N carriers, a carrier for transmitting a service having a lowest priority (when there are multiple carriers with the same priority, the terminal device decides independently which one to choose), and adjusting a transmission power of the carrier;
step b) after adjusting the transmission power of the carrier, if a sum of transmission powers of the N carriers still exceeds the maximum transmission power of the terminal device, discarding the service to be transmitted on the carrier;
step c) after discarding the service to be transmitted on the carrier, if a sum of transmission powers of the N carriers is still greater than the maximum transmission power of the terminal device, selecting another carrier with the priority, and repeating steps a), b), and c); and
step d) after the transmission power of each of the carriers with the priority is adjusted, if a sum of transmission powers of the N carriers is still greater than the maximum transmission power of the terminal device, reducing the priority value by one, and repeating step a), step b), step c), and step d), namely, adjusting the transmission power of a carrier with a next priority. It should be noted that a priority value is in inversely proportional to a priority, namely, the greater the priority value is, the lower the priority is, and vice versa, the smaller the priority value is, the higher the priority is, description is made in the present disclosure by taking this as an example. In a practical implementation, it may also be that, the smaller the priority value is, the lower the priority is, and the greater the priority value is, the higher the priority is.

The foregoing steps a), b), c) and d) are executed cyclically until the sum of transmission powers of the N carriers is less than or equal to the maximum transmission power of the terminal device.

However, since the HARQ feedback mechanism (which is not available in LTE V2X) is introduced to NR V2X, if the transmission power control method for LTE V2X CA is still used, it may incur that some HARQ feedbacks are discarded, thereby resulting in unnecessary retransmissions. Or, when a priority of a service to be transmitted on a certain carrier is very low, it may incur that an HARQ feedback is impossible for the service for a long time, thus, resulting in unnecessary waste of resources and affecting other transmissions.

Therefore, in an NR V2X scenario, it is also an urgent problem to be addressed in respect of how a terminal device should take the HARQ feedback into account when performing transmission power control.

In view of the above, the present disclosure provides a communication method and apparatus, a storage medium, and a program product, which are used for implementing transmission power control in NR V2X.

The communication method and apparatus, the storage medium, and the program product provided in the present application can be adaptable to transmission power control in NR V2X.

The embodiments of the present disclosure provide several transmission power control methods suitable for NR V2X.

Transmission power control method 1: adjusting a transmission power, based on a priority of a service to be transmitted on each of the carriers, and for a same priority, based on an adjustment order related to a type of a channel/signal to be transmitted on carriers, so as to achieve transmission power control. Through the transmission power control method, it can be guaranteed that the transmission of a more important service, and a more important channel/signal is prioritized.

Transmission power control method 2: based on a transmission power adjustment weight configured for each of the carriers, adjusting the transmission power of each of the carriers, so as to achieve transmission power control. Through the transmission power control method, it can be permitted that services on all of the carriers can be transmitted, thereby, a requirement can be met when the services on all of the carriers must be transmitted.

Transmission power control method 3: dividing the maximum transmission power P of the terminal device into P1 and P2, where P1 is used for transmission power control on carriers used for transmitting first information, P2 is used for transmission power control on carriers used for transmitting information other than the first information. That is, transmission power control is independently performed on carriers for the two corresponding portions of channels/signals, so as to achieve transmission power control. Through the transmission power control method, both the transmission of the first information and the transmission of other services are taken into account, thereby avoiding unnecessary retransmissions resulting from the discarding of the first information, and reducing a waste of resources resulting from the unnecessary retransmissions. The first information is used to feedback data reception status of a first terminal device. The first information may be, for example, a HARQ feedback.

It should be noted that the process of transmission power control on the carriers, as described in the embodiments of the present disclosure, is namely the process of performing transmission power adjustment on the carriers. In the embodiments of the present disclosure, transmission power control and transmission power adjustment convey a same meaning, which are not distinguished in the present disclosure.

The following takes an example where the first terminal device (for example, the terminal device 121) is an executing subject, and specifies these control methods in detail in conjunction with specific embodiments. The following specific embodiments can be combined with each other, for the same or similar concepts or processes, description may not be repeated in some embodiments.

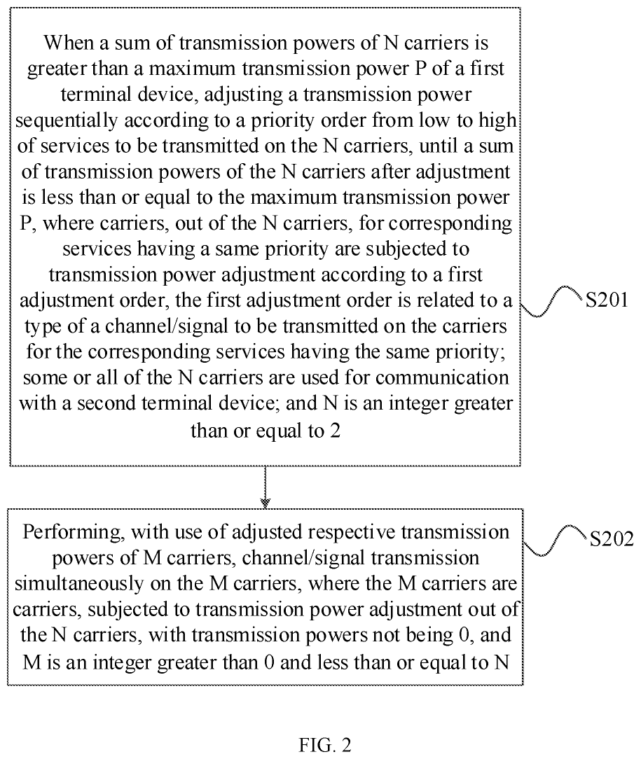

FIG. 2 is a schematic flowchart of a communication method according to an embodiment of the present disclosure. The embodiment relates to the process of performing channel/signal transmission using the transmission power control method 1, namely, the process of performing transmission power control based on priorities. As shown in FIG. 2, the method may include the steps as follows.

S201, when a sum of transmission powers of N carriers is greater than a maximum transmission power P of a first terminal device, adjusting a transmission power sequentially based on a priority order from low to high of services to be transmitted on the N carriers, until a sum of transmission powers of the N carriers after adjustment is less than or equal to P, where carriers, out of the N carriers, for corresponding services having a same priority are subjected to transmission power adjustment based on a first adjustment order, the first adjustment order is related to a type of a channel/signal to be transmitted on the carriers for the corresponding services having the same priority; some or all of the N carriers are used for communication with a second terminal device (for example, the terminal device 122); and N is an integer greater than or equal to 2.

It should be understood that the mentioned N carriers are N carriers used by the first terminal device in a current time unit. The time unit mentioned here may be, for example, a frame, a subframe, a time slot, an orthogonal frequency division multiplexing (Orthogonal Frequency Division Multiplexing, OFDM) symbol, etc.

The N carriers are used for channel/signal transmission. It should be noted that the channel transmission as described in the embodiments of the present disclosure can be interpreted as transmission of information carried on the channels. The information carried on the channels can be: control information of a certain service, data of a certain service, first information that is used to feedback data reception status of the first terminal device (for example, data reception status of a certain service), etc.

When all of the carriers of the N carriers are used for channel/signal transmission to the second terminal device, the first terminal device can use all of the carriers in a CA manner for channel/signal transmission to the second terminal device. When some carriers of the N carriers are used for channel/signal transmission to the second terminal device, the first terminal device can use the mentioned some of the carriers in a CA manner for channel/signal transmission to the second terminal device. The rest carriers of the N carriers can be used for channel/signal transmission to the network device.

It should be noted that the transmission power of a carrier, as in the description that a sum of transmission powers of N carriers is greater than the maximum transmission power P of the first terminal device, can be a maximum transmission power allocated to the carrier in the first place.

A priority, as related to in this embodiment and subsequent embodiments of the present disclosure, refers to a priority of a service to be transmitted on a carrier. Therefore, in the embodiments of the present disclosure, the three wordings of a priority, a priority of a service, and a service priority are equivalent, which are not distinguished in this regard.

S202, performing, with use of adjusted respective transmission powers of M carriers, channel/signal transmission simultaneously on the M carriers, where the M carriers are carriers, subjected to transmission power adjustment out of the N carriers, with transmission powers not being 0, and M is an integer greater than 0 and less than or equal to N.

If the M carriers are carriers, out of the N carriers, used for communication with the second terminal device, the first terminal device transmits channels/signals to the second terminal device by using the M carriers. If the M carriers include both the carriers for communication with the second terminal device and carriers for communication with the network device, the first terminal device transmits channels/signals to the second terminal device by using the carriers, out of the M carriers, for communication with the second terminal device, and transmits channels/signals to the network device by using the carriers, out of the M carriers, for communication with the network device. The M carriers can be specifically determined based on remaining carriers with transmission powers not being 0 after transmission power adjustment to the N carriers.

In the embodiment, the first terminal device adopts the following method to perform transmission power control, namely, step S201 may include the following.

Step A): selecting, from the N carriers, a carrier for transmitting a service of a lowest priority, and adjusting a transmission power of the carrier. Namely, perform transmission power control on the carrier by means of adjusting the transmission power of the carrier.

The adjusting the transmission power as mentioned here may refer to reducing a transmission power of a carrier; or, discarding a service to be transmitted on the carrier (namely, setting the transmission power of the carrier to be 0); or, after reducing the transmission power of the carrier, if the sum of the transmission powers of the N carriers is still greater than the maximum transmission power P of the first terminal device, discarding the service to be transmitted on the carrier. In a specific implementation, which transmission power control manner should be specifically applied for a certain carrier can be determined by the first terminal device independently; or, it can be specified in a protocol, and the first terminal device performs transmission power control based on the provisions of the protocol.

It should be understood that when there are multiple carriers for the same priority, the carrier is the first one of the multiple carriers based on the first adjustment order. The first adjustment order is related to a type of a channel/signal to be transmitted on the multiple carriers. For an explanation to the first adjustment order, reference may be made to the following description.

Step B): after adjusting the transmission power of the carrier, if a sum of transmission powers of the N carriers still exceeds the maximum transmission power P of the first terminal device, selecting a next carrier corresponding to the priority based on the first adjustment order, and repeating steps A) and B).

Step C): after the transmission power of each of the carriers for with the priority is adjusted, if a sum of transmission powers of the N carriers is still greater than the maximum transmission power of the first terminal device, reducing the priority value by one, and repeating step A), step B), and step C), namely, adjusting the transmission power of a carrier for a next priority. It should be noted that a priority value is inversely proportional to a priority, that is, the greater the priority value is, the lower the priority is, and vice versa, the smaller the priority value is, the higher the priority is.

The foregoing step A), step B), and step C) are executed cyclically until the sum of the transmission powers of the N carriers is less than or equal to the maximum transmission power P of the first terminal device. Namely, upon completion of transmission power adjustment to a certain carrier, when the sum of the transmission powers of the N carriers is less than or equal to the maximum transmission power P of the first terminal device, stop performing transmission power adjustment to the rest of the carriers. At this point, the transmission powers of the rest of the carriers are a maximum transmission power as allocated to these carriers in the first place.

Based on the above description, it can be seen that in the embodiment, although the priority order from low to high of services to be transmitted on the carriers is also used to perform adjustment on the carriers, the embodiment further takes into account of a type difference among channels/signals to be transmitted on the carriers, thereby, in combination with a type of a channel/signal to be transmitted on the carriers for services of a same priority, the first adjustment order which is determined based on a channel/signal type is determined for multiple carriers of a same priority, permitting that a carrier for transmitting a channel/signal of a more important type is ranked lower in the order for transmission power adjustment, thereby, the transmission of the channel/signal of a more important type can be guaranteed.

In an implementation, the aforementioned first adjustment order can be predefined.

Or, the aforementioned first adjustment order can be indicated by the network device. For example, the network device can send, to the first terminal device, indication information which is used for indicating the first adjustment order. Correspondingly, the first terminal device can receive the indication information. For ease of distinguishing, the indication information which is used for indicating the first adjustment order is referred to as first indication information.

Or, the aforementioned first adjustment order can be selected independently by the first terminal device from at least one adjustment order indicated by the network device. For example, the network device can send, to the first terminal device, indication information which is used for indicating at least one adjustment order. Correspondingly, the first terminal device can receive the indication information, and based on the indication information, determine one adjustment order in the at least one adjustment order to be the first adjustment order. For ease of distinguishing, the indication information which is used for indicating the at least one adjustment order is referred to as second indication information.

As an example, the network device can, for example, send the aforementioned first indication information or second indication information to the first terminal device through high-layer signaling, such as radio resource control (Radio Resource Control, RRC) signaling, a media access control (Media Access Control, MAC) control element (Control Element, CE), or the like.

In an implementation, the first adjustment order can be based on a further subdivided channel/signal type of information carried by the channel/signal, such that the first adjustment order can be set for the multiple carriers for a same service priority further based on the subdivided types, permitting that a carrier for transmitting a channel/signal of a more important type is ranked lower in the order for transmission power adjustment, thereby, the transmission of the channel/signal of a more important type can be guaranteed.

The aforementioned channels/signals to be transmitted on the N carriers are not limited in the present disclosure.

For example, the aforementioned N carriers may include a carrier for transmitting first information. The first information may be, for example, a HARQ feedback. Namely, the method provided in the embodiment can be applied to a scenario supporting the HARQ feedback, for example, NR V2X, or V2X of other communication systems.

For another example, in the aforementioned N carriers, there may not exist a carrier for transmitting the first information. Namely, the method provided in the embodiment can be applied to a V2X scenario without the HARQ feedback, for example, LTE V2X, NR V2X, or the like.

Take the NR V2X supporting the HARQ feedback as an example, for example, assuming that the channels/signals to be transmitted on the N carriers can be divided, for example, into the following four categories:
a synchronization signal block (Synchronization signal block, SSB);
a physical sidelink feedback channel (Physical Sidelink Feedback Channel, PSFCH);
a physical uplink control channel (Physical Uplink Control Channel, PUCCH)/physical uplink shared channel (Physical Uplink Shared Channel, PUSCH); and
a physical sidelink shared channel (Physical Sidelink Shared Channel, PSSCH)/physical sidelink control channel (Physical Sidelink Control Channel, PSCCH);
where the PSFCH, PUCCH, and PUSCH support HARQ information transmission.

As described above, in the first adjustment order, the more important a channel/signal to be transmitted is, the lower the rank in the order for transmission power adjustment is. Take an example where the importance of various channels/signals in a communication system is considered from the perspective of the impact on stability of the communication system, assuming that the greater impact on stability is, the higher the importance is, namely, the SSB used for synchronization signal transmission has the highest importance, the PSFCH used for the HARQ feedback transmission takes the second place, and other channels have the lowest importance. In this example, for carriers for a same priority, the first adjustment order determined based on the channels/signals to be transmitted on the carriers can be, for example, as follows:
21) PSSCH/PSCCH, PUCCH/PUSCH;
22) PSFCH;
23) SSB.

Namely, the aforementioned first adjustment order is related to the importance of various channels/signals in a communication system. A channel/signal of more importance is ranked lower in the first adjustment order, and thus ranked lower in the order for transmission power adjustment, such that it can be guaranteed that the transmission of a more important channel/signal is prioritized, thereby, guaranteeing the stability of the communication system.

It should be understood that the above description merely provides, for an illustrative purpose, the first adjustment order when the N carriers are used for transmitting the four types of channels/signals. The first adjustment order corresponding to the four types of channels/signals is not limited as such in the present disclosure, and it can be determined and adjusted based on a practical requirement.

In an implementation, for a same priority, the first adjustment order for the aforementioned four types of channels/signals can be based on a further subdivision of information carried thereby (for example, the PSSCH can be divided into a PSSCH carrying common service data and a PSSCH carrying channel state information (Channel State Information, CSI) feedback information; and the PUCCH can be divided into a PUCCH carrying uplink control information (Uplink Control Information, UCI) and a PUCCH containing side link HARQ feedback information, etc.). In a specific implementation, the first adjustment order can be set for multiple carriers for a same service priority further based on subdivided types, permitting that a carrier for transmitting a channel/signal of a more important type has a lower ranking in the order of transmission power adjustment, thereby, the transmission of the channel/signal of a more important type is guaranteed.

To sum up, the transmission power control method 1 can be summarized as the following:
due to a limitation of the maximum transmission power of the first terminal device, allocating transmission powers to different channels/signals based on the following index from top to bottom;
prioritizing allocation of a transmission power to a carrier for transmitting a service of a higher priority;
for carriers for transmitting services of a same priority, allocating transmission powers sequentially based on different channel/signal types; for example, allocating the transmission powers sequentially based on the following order:
   (1) SSB;
   (2) PSFCH;
   (3) PUCCH & PUSCH & PSCCH & PSSCH
for multiple carriers which are intended for a same priority and are used for transmitting channels/signals of a same type, the first terminal device determines independently a carrier to which the transmission power is allocated to;
allocating a remaining transmission power to a certain carrier, in the carriers allocated with no transmission power, which is intended for a highest priority or which corresponds to channel/signals of a top ranked order under a same priority.

It should be noted that in the embodiment, the aforementioned first terminal device can work under a single network type, for example, all of the N carriers can be carriers used for channel/signal transmission of a service of a first network type. Take an example where the first network type is NR, all of the N carriers are used for channel/signal transmission of an NR service.

The aforementioned first terminal device can also work under both of the first network type and a second network type, namely, in a scenario of two network types which are assumed as the first network type and the second network type. As an example, the first network type can be NR, the second network type can be LTE, and vice versa. In such a scenario, two cases may be included.

Case 1: the first terminal device supports simultaneous transmission of carriers for transmitting services of two network types.

In case 1, the N carriers can include X carriers for channel/signal transmission of a service of the first network type, and Y carriers for channel/signal transmission of a service of the second network type; where X and Y are both positive integers, and a sum of X and Y is equal to N. For example, in an NR-LTE coexisting scenario, the N carriers include X carriers for channel/signal transmission of an LTE service, and Y carriers for channel/signal transmission of an NR service.

In the scenario where the first terminal device supports simultaneous transmission of carriers for transmitting services of two network types, the first terminal device can use any of the following modes for transmission power control.

Mode 1: performing transmission power control sequentially based on priorities of the service of the first network type and the service of the second network type.

For example, if the priority of the service of the first network type is higher than the priority of the service of the second network type, transmission power control is firstly performed on the Y carriers for channel/signal transmission of the service of the second network type first; after the transmission power control, if a sum of transmission powers is still greater than the maximum transmission power P of the first terminal device, transmission power control is further performed on the X carriers for channel/signal transmission of the service of the first network type.

For another example, if the priority of the service of the second network type is higher than the priority of the service of the first network type, transmission power control is firstly performed on the X carriers for channel/signal transmission of the service of the first network type; after the transmission power control, if a sum of transmission powers is still greater than the maximum transmission power P of the first terminal device, transmission power control is further performed on the Y carriers for channel/signal transmission of the service of the second network type.

It should be noted that the transmission power adjustment order for a respective carrier out of the carriers corresponding to each of the network types can be determined using the aforementioned method as shown in FIG. 2.

In an implementation, the aforementioned priorities of the service of the first network type and the service of the second network type can be predefined.

Or, the aforementioned priorities of the service of the first network type and the service of the second network type can be determined by the first terminal device independently.

Or, the aforementioned priorities of the service of the first network type and the service of the second network type can be configured by the network device. For example, the network device can send configuration information to the first terminal device, where the configuration information is used for configuring the priorities of the service of the first network type and the service of the second network type. Correspondingly, the first terminal device receives the configuration information to obtain the priorities of the service of the first network type and the service of the second network type.

Mode 2: processing the priorities of the services of the two network types as equivalents, and performing transmission power control jointly on the X carriers for channel/signal transmission of the service of the first network type and the Y carriers for channel/signal transmission of the service of the second network type. Namely, the method as shown in FIG. 2 is directly used to perform transmission power control on the N carrier.

Take an NR-LTE coexisting scenario as an example, processing the priorities as equivalents as described above means that priorities of 8 services in LTE from high to low are in a one-to-one correspondence with priorities of 8 services in NR from high to low. Take a carrier for transmitting an NR service whose priority is 2 and a carrier for transmitting an LTE service whose priority is 2 as an example, in the implementation mode, based on the principle of processing the priorities as equivalents, the two carriers are of a same priority during transmission power control.

It should be noted that, in the scenario where the first terminal device supports simultaneous transmission of carriers for transmitting services of two network types, whether mode 1 or mode 2 is specifically used for transmission power control can be predefined, or determined by the first terminal device independently, or indicated by the network device through a high layer, which is not limited in the present disclosure.

Case 2: the first terminal device does not support simultaneous transmission of carriers for transmitting services of two network types. Namely, only transmission of services of one network type is supported in a same time instant, and the first terminal device can determine independently a network type the services of which is prioritized for transmission; or, determine, based on predefined priorities, a network type the services of which is prioritized for transmission; or, determine, based on an indication of the network device, a network type the services of which is prioritized for transmission.

It should be noted that, when transmission power adjustment is to be performed on carriers corresponding to the two network types respectively and independently, the aforementioned transmission power adjustment performed based on the priorities of FIG. 2 can be adopted for both, or the aforementioned transmission power adjustment performed based on the priorities of FIG. 2 can be adopted for one of the network types.

As an example, take an NR-LTE coexisting scenario as an example, for carriers for channel/signal transmission of an NR service, the aforementioned transmission power adjustment performed based on the priorities of see FIG. 2 can be adopted, and for carriers for channel/signal transmission of an LTE service, a transmission power control method for LTE V2X can be adopted, or the aforementioned transmission power adjustment performed based on the priorities of see FIG. 2 can be adopted as well.

According to the method provided in the embodiments of the present disclosure, the first terminal device can perform transmission power adjustment, based on a priority of a service to be transmitted on each of the carriers, and for a same priority, perform transmission power adjustment based on an adjustment order related to a type of channel/signal to be transmitted on the carriers. Through the transmission power control method, it can be guaranteed that the transmission of a more important service, and a more important channel/signal is prioritized.

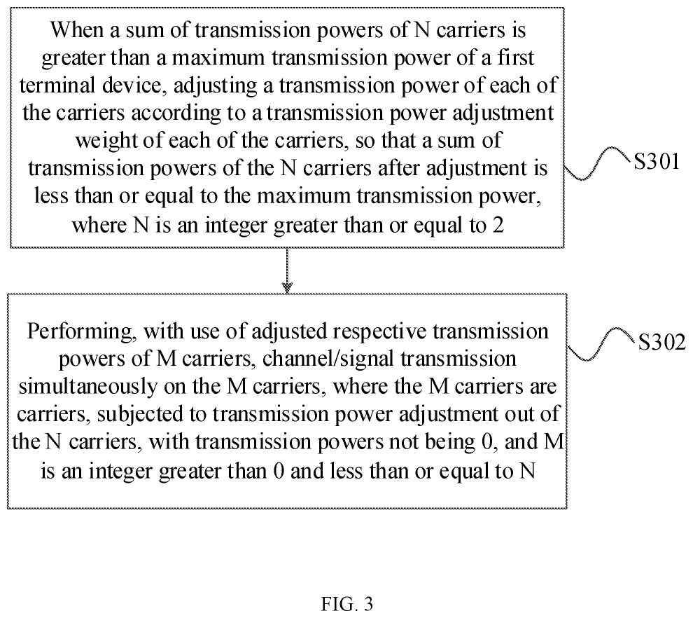

FIG. 3 is another schematic flowchart of a communication method according to an embodiment of the present disclosure. The embodiment relates to the process of performing channel/signal transmission by using the transmission power control method 2, namely, the process of performing transmission power control based on a transmission power adjustment weight of each carrier. As shown in FIG. 3, the method may include the steps as follows.

S301, when a sum of transmission powers of N carriers is greater than a maximum transmission power of a first terminal device, adjusting a transmission power of each of the carriers based on a transmission power adjustment weight of each of the carriers, so that a sum of transmission powers of the N carriers after adjustment is less than or equal to the maximum transmission power, where N is an integer greater than or equal to 2.

S302, performing, with use of adjusted respective transmission powers of M carriers, channel/signal transmission simultaneously on the M carriers, where the M carriers are carriers, subjected to transmission power adjustment out of the N carriers, with transmission powers not being 0, and M is an integer greater than 0 and less than or equal to N.

In the embodiment, the same or similar concepts as/to that in the foregoing embodiment as shown in FIG. 2 will not be explained again.

In the embodiment, each of the carriers has a transmission power adjustment weight. The first terminal device can perform transmission power control based on the transmission power adjustment weight of each of the carriers, it can be permitted that services on all of the carriers can be transmitted, thereby, a requirement can be met when the services on all of the carriers must be transmitted.

For example, the first terminal device can, for example, implement the transmission power adjustment through formula (1) as follows:

$${\sum }_{c} {w}_{c} {P}_{CMAX , c} \leq P \qquad ( 1 )$$

where c represents a carrier; P_{CMAX,c} represents a maximum transmission power of the carrier c; w_{c} is a transmission power adjustment weight of the carrier, for example, it can be any value in [0,1]; and w_{c}P_{CMAX,c} is an actual transmission power of the carrier c after transmission power adjustment, and P is a maximum transmission power of the first terminal device.

In an implementation, the N carriers may have a same transmission power adjustment weight, or some of the carriers may have a same transmission power adjustment weight.

When the transmission power adjustment weight of each of the carriers is a value greater than 0 and less than 1, it means that the first terminal device has performed transmission power adjustment on each of the carriers, and the implementation permits that services on all of the carriers can be transmitted. In an implementation, the transmission power adjustment weight of some carrier can be set to 0, to discard a service to be transmitted on the carrier. Or, the transmission power adjustment weight of some carrier can be set to 1, such that a service to be transmitted on the carrier is guaranteed. By means of setting a transmission power adjustment weight for each of the carriers, carriers on which the transmission power adjustment is to be performed can be flexibly selected, thereby permitting more flexibility for application scenarios.

In an implementation, in the N carriers, carriers satisfying a first condition have a same transmission power adjustment weight, where the first condition includes at least one of the following: being used for transmitting services of a same priority, or being used for transmitting channels/signals of a same type.

For example, the transmission power adjustment weight of a carrier can be related to the priority of a service to be transmitted. For example, carriers that have a same priority have a same transmission power adjustment weight. Or, the transmission power adjustment weight of a carrier can be related to the type of a channel/signal to be transmitted on the carrier. For example, carriers for transmitting channels/signals of a same type have a same transmission power adjustment weight. Or, the transmission power adjustment weight of a carrier can be related to the priority of a service to be transmitted, and the type of a channel/signal to be transmitted on the carrier. For example, carriers that have a same priority and are used for transmitting channels/signals of a same type have a same transmission power adjustment weight.

As an example where the transmission power adjustment weight of a carrier can be related to the priority of a service to be transmitted, and the type of a channel/signal to be transmitted on the carrier, the first terminal device can, for example, implement the transmission power adjustment through formula (2) as follows:

$${\sum }_{type} {\sum }_{i} {\sum }_{{c}_{i}} {w}_{type , i} {P}_{CMAX , {c}_{i}} \leq P \qquad ( 2 )$$

where type in the first summation term represents a channel/signal type; i in the second summation term represents a priority; cᵢ in the third summation term represents a current carrier whose priority is i, w_{type,i} represents a transmission power adjustment weight of a carrier when the channel/signal type is type and the priority is i; P_{CMAX,c}_{ᵢ} is a maximum transmission power corresponding to the carrier cᵢ.

In this way, different transmission power adjustment weights can be set for carriers which have different priorities, and different channel/signal types. For example, a greater transmission power adjustment weight can be set for a carrier for transmitting a service which has a higher priority, and is intended for transmitting a channel/signal of a more important type, such that the transmission of a channel/signal of a more important type can be guaranteed.

In an implementation, a type of a channel/signal can be further subdivided based on information carried by the channel/signal, such that a transmission power adjustment weight can be set for the carrier further based on a subdivided type, thereby, the transmission of a channel/signal of a more important type can be guaranteed.

In an implementation, the aforementioned transmission power adjustment weights of the N carriers can be predefined.

Or, the transmission power adjustment weights of the N carriers can be determined by the first terminal device independently.

Or, the transmission power adjustment weights of the N carriers can be indicated by the network device. For example, the network device can send, to the first terminal device, indication information which is used for indicating the transmission power adjustment weights of the N carriers. Correspondingly, the first terminal device can receive the indication information. For ease of distinguishing, the indication information which is used for indicating the transmission power adjustment weights of the N carriers is referred to as third indication information.

Or, the transmission power adjustment weights of the N carriers can be selected independently by the first terminal device from at least one group of transmission power adjustment weights indicated by the network device. For example, the network device can send, to the first terminal device, indication information which is used for indicating at least one group of transmission power adjustment weights. Correspondingly, the first terminal device can receive the indication information, determine the at least one group of transmission power adjustment weights based on the indication information, and determine a transmission power adjustment weight in the at least one group of transmission power adjustment weights to be the transmission power adjustment weight which will be used by itself. For ease of distinguishing, the indication information which is used for indicating the at least one group of transmission power adjustment weights is referred to as fourth indication information.

As an example, the network device can, for example, send the aforementioned third indication information or fourth indication information to the first terminal device through high-layer signaling, such as RRC signaling, a MAC CE, or the like.

The aforementioned channels/signals to be transmitted on the N carriers are not limited in the present disclosure.

For example, the aforementioned N carriers may include a carrier for transmitting first information. The first information may be, for example, a HARQ feedback. Namely, the method provided in the embodiment can be applied to a scenario supporting the HARQ feedback, for example, NR V2X, or V2X of other communication systems.

For another example, in the aforementioned N carriers, there may exist no carrier for transmitting the first information. Namely, the method provided in the embodiment can be applied to a scenario without the HARQ feedback, for example, LTE V2X, NR V2X, or the like.

It should be noted that some or all of the aforementioned N carriers can be used for communication with a second terminal device. Namely, the method according to the embodiment can be applied to a V2X scenario. In an implementation, the aforementioned N carriers can also be used for communication with the network device, or the like. Namely, the method according to the embodiment can also be used for an uplink transmission.

It should be noted that in the embodiment, the aforementioned first terminal device can work under a single network type, for example, all of the N carriers can be carriers used for transmitting channels/signals of a service of a first network type.

The aforementioned first terminal device can also work under both of the first network type and a second network type, namely, in a scenario of two network types which are assumed as the first network type and the second network type.

In such a scenario, two cases may be included.

Case 1: the first terminal device supports simultaneous transmission of carriers for transmitting services of two network types.

In case 1, the N carriers can include X carriers for channel/signal transmission of a service of the first network type, and Y carriers for channel/signal transmission of a service of the second network type; where X and Y are both positive integers, and a sum of X and Y is equal to N.

In the scenario where the first terminal device supports simultaneous transmission of carriers for transmitting services of two network types, the first terminal device can use any of the following modes for transmission power control.

Mode 1: performing transmission power control sequentially based on priorities of the service of the first network type and the service of the second network type.

For example, if the priority of the service of the first network type is higher than the priority of the service of the second network type, the transmission power adjustment weight of each of the X carriers for channel/signal transmission of the service of the first network type, is greater than the transmission power adjustment weight of each of the Y carriers for channel/signal transmission of the service of the second network type. Namely, a minimum value of the transmission power adjustment weights of the X carriers for channel/signal transmission of the service of the first network type, is greater than a maximum value of the transmission power adjustment weights of the Y carriers for channel/signal transmission of the service of the second network type.

For another example, if the priority of the service of the second network type is higher than the priority of the service of the first network type, the transmission power adjustment weight of each of the Y carriers for channel/signal transmission of the service of the second network type, is greater than the transmission power adjustment weight of each of the X carriers for channel/signal transmission of the service of the first network type. Namely, a minimum value of the transmission power adjustment weights of the Y carriers for channel/signal transmission of the service of the second network type, is greater than a maximum value of the transmission power adjustment weights of the X carriers for channel/signal transmission of the service of the first network type.

It should be noted that the transmission power adjustment weight of a respective carrier in the carriers corresponding to each of the network types can be determined using the aforementioned method as shown in FIG. 3.

In an implementation, the aforementioned priorities of the service of the first network type and the service of the second network type can be predefined.

Or, the aforementioned priorities of the service of the first network type and the service of the second network type can be determined by the first terminal device independently.

Or, the aforementioned priorities of the service of the first network type and the service of the second network type can be configured by the network device. For example, the network device can send configuration information to the first terminal device, where the configuration information is used for configuring the priorities of the service of the first network type and the service of the second network type. Correspondingly, the first terminal device receives the configuration information to obtain the priorities of the service of the first network type and the service of the second network type.

Mode 2: processing the priorities of the services of the two network types as equivalents, performing transmission power control jointly on the X carriers for channel/signal transmission of the service of the first network type and the Y carriers for channel/signal transmission of the service of the second network type. Namely, the method as shown in FIG. 3 is directly used to perform transmission power control on the N carrier.

It should be noted that, in the scenario where the first terminal device supports simultaneous transmission of carriers for transmitting services of the two network types, whether mode 1 or mode 2 is specifically used for transmission power control can be predefined, or determined by the first terminal device independently, or indicated by the network device through a high layer, which is not limited in the present disclosure.

Case 2: the first terminal device does not support simultaneous transmission of carriers for transmitting services of two network types. Namely, only transmission of services of one network type is supported in a same time instant, and the first terminal device can determine independently a network type the services of which is prioritized for transmission; or, determine, based on predefined priorities, a network type the services of which is prioritized for transmission; or, determine, based on an indication of the network device, a network type the services of which is prioritized for transmission.

It should be noted that, when transmission power adjustment is to be performed on carriers corresponding to the two network types respectively and independently, the aforementioned transmission power adjustment performed based on the transmission power adjustment weight of each of carriers of see FIG. 3 can be adopted for both, or the aforementioned transmission power adjustment performed based on the transmission power adjustment weight of each of carriers of see FIG. 3 can be adopted for one of the network types.

As an example, take an NR-LTE coexisting scenario as an example, for carriers for channel/signal transmission of an NR service, the aforementioned transmission power adjustment performed based on the transmission power adjustment weight of each of carriers of see FIG. 3 can be adopted, and for carriers for channel/signal transmission of an LTE service, a transmission power control method for LTE V2X can be adopted, or the aforementioned transmission power adjustment performed based on the transmission power adjustment weight of each of carriers of see FIG. 3 can be adopted as well.

According to the method provided in the embodiment of the present disclosure, the first terminal device can perform, based on a transmission power adjustment weight configured for each of the carriers, transmission power adjustment for each of the carriers, so as to achieve transmission power control. Through the method, in addition to achieving transmission power control, it can be permitted that services on all of the carriers can be transmitted, thereby, a requirement can be met when the services on all of the carriers must be transmitted. Namely, the transmission power control method based on the embodiment is applicable to an application scenario where the services on all of the carriers must be transmitted.

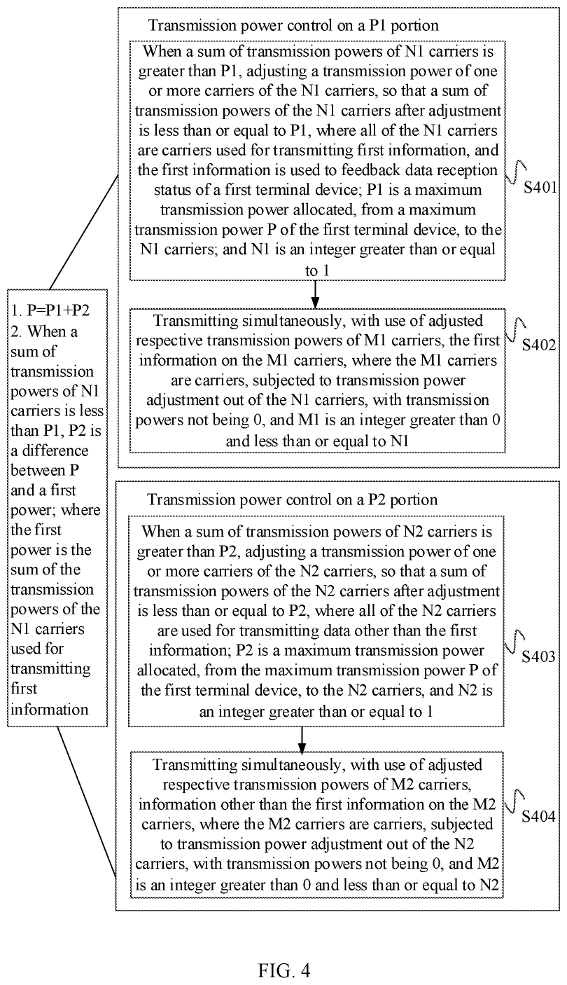

FIG. 4 is yet another schematic flowchart of a communication method according to an embodiment of the present disclosure. The embodiment relates to the process of performing channel/signal transmission by using the transmission power control method 3, namely, a process of dividing the maximum transmission power P of the first terminal device into P1 and P2, performing transmission power control independently, through P1, on carriers used for transmitting first information for data reception status, and performing transmission power control independently, through P2, on carriers used for transmitting information other than the first information.

The following explains how to perform transmission power control independently, through P1, on carriers used for transmitting the first information for data reception status, and how to perform transmission power control independently, through P2, on carriers used for transmitting information other than the first information. The information other than the first information can be, for example, control information of a certain service, data of a certain service, or the like.

As shown in FIG. 4, the portion of performing transmission power control independently, through P1, on carriers used for transmitting the first information for data reception status, can be implemented, for example, through the following steps.

S401, when a sum of transmission powers of N1 carriers is greater than P1, adjusting a transmission power of one or more carriers of the N1 carriers, so that a sum of transmission powers of the N1 carriers after adjustment is less than or equal to P1, where all of the N1 carriers are carriers used for transmitting first information, and the first information is used to feedback data reception status of the first terminal device; P1 is a maximum transmission power allocated, from a maximum transmission power P of the first terminal device, to the N1 carriers; and N1 is an integer greater than or equal to 1.

It should be understood that the mentioned N1 carriers are multiple carriers which are used by the first terminal device in a current time unit, and can be used for transmitting the first information. The time unit mentioned here may be, for example, a frame, a subframe, a time slot, an OFDM symbol, etc.

All carriers of the N1 carriers can be used for transmitting the first information to a second terminal device; or some carriers of the N1 carriers are used for transmitting the first information to the second terminal device, and the rest of the carriers can be used for transmitting the first information to the network device.

When all carriers of the N1 carriers can be used for transmitting the first information to the second terminal device, the first terminal device can use all of the carriers in a CA manner to transmit the first information to the second terminal device. When some carriers of the N1 carriers are used for transmitting the first information to the second terminal device, the first terminal device can use the mentioned some of the carriers in a CA manner to transmit the first information to the second terminal device, and the rest of the N carriers can be used to transmit the first information to the network device.

The method for adjusting the transmission power(s) of one or more carriers of the N1 carriers is not limited in the embodiment. For example, the method as shown in FIG. 2 where transmission power adjustment is performed based on the priorities can be adopted, so as to adjust the transmission power(s) sequentially based on a priority order from low to high of services to be transmitted on the N1 carriers, until a sum of transmission powers of the N1 carriers after adjustment is less than or equal to P1. For the specific implementation, reference can be made to the description in the foregoing embodiment corresponding to FIG. 2, to which the implementation principle thereof is similar, and will not be repeated here.

Or, the method as shown in FIG. 3 where transmission power adjustment is performed based on the transmission power adjustment weight of each of the carriers can be adopted, so as to adjust, based on the transmission power adjustment weight of each carrier of the N1 carriers, the transmission power of each of the carriers. For the specific implementation, reference can be made to the description in the foregoing embodiment corresponding to FIG. 3, to which the implementation principle thereof is similar, and will not be repeated here.

S402, transmitting simultaneously, with use of adjusted respective transmission powers of M1 carriers, the first information on the M1 carriers, where the M1 carriers are carriers, subjected to transmission power adjustment out of the N1 carriers, with transmission powers not being 0, and M1 is an integer greater than 0 and less than or equal to N1.

It should be noted that, in the embodiment, the same or similar concepts as/to that in the embodiments as shown in FIG. 2 and FIG. 3 will not be explained again.

As shown in FIG. 4, performing transmission power control independently, through P2, on carriers used for transmitting information other than the first information, can be implemented, for example, through the following steps.

S403, when a sum of transmission powers of N2 carriers is greater than P2, adjusting a transmission power of one or more carriers of the N2 carriers, so that a sum of transmission powers of the N2 carriers after adjustment is less than or equal to P2, where all of the N2 carriers are used for transmitting information other than the first information; P2 is a maximum transmission power allocated, from the maximum transmission power P of the first terminal device, to the N2 carriers, and N2 is an integer greater than or equal to 1.

It should be understood that the mentioned N2 carriers are multiple carriers which are used by first terminal device in a current time unit, and can be used for transmitting information other than the first information.

All carriers of the N2 carriers can be used for transmitting information other than the first information to the second terminal device; or some carriers of the N2 carriers are used for transmitting information other than the first information to the second terminal device, and the rest of the carriers can be used for transmitting information other than the first information to the network device.

When all carriers of the N2 carriers can be used for transmitting information other than the first information to the second terminal device, the first terminal device can use all of the carriers in a CA manner to transmit information other than the first information to the second terminal device. When some carriers of the N2 carriers are used for transmitting information other than the first information to the second terminal device, the first terminal device can use the mentioned some of the carriers in a CA manner to transmit information other than the first information to the second terminal device, and the rest of the N2 carriers can be used to transmit information other than the first information to the network device.

The method for adjusting the transmission power(s) of one or more carriers of the N2 carriers is not limited in the embodiment. For example, the method as shown in FIG. 2 where transmission power adjustment is performed based on the priorities can be adopted, so as to adjust the transmission power(s) sequentially based on a priority order from low to high of services to be transmitted on the N2 carriers, until a sum of transmission powers of the N2 carriers after adjustment is less than or equal to P2. For the specific implementation, reference can be made to the description in the foregoing embodiment corresponding to FIG. 2, to which the implementation principle thereof is similar, and will not be repeated here.

Or, the method as shown in FIG. 3 where transmission power adjustment is performed based on the transmission power adjustment weight of each of the carriers can be adopted, so as to adjust, based on the transmission power adjustment weight of each carrier of the N2 carriers, the transmission power of each of the carriers. For the specific implementation, reference can be made to the description in the foregoing embodiment corresponding to FIG. 3, to which the implementation principle thereof is similar, and will not be repeated here.

Or, the transmission power control method for LTE V2X or the like, which is described in the foregoing description, can be adopted.

S404, transmitting simultaneously, with use of adjusted respective transmission powers of M2 carriers, information other than the first information on the M2 carriers, where the M2 carriers are carriers, subjected to transmission power adjustment out of the N2 carriers, with transmission powers not being 0, and M2 is an integer greater than 0 and less than or equal to N2.

It should be noted that, in the embodiment, the same or similar concepts as/to that in the embodiments as shown in FIG. 2 and FIG. 3 will not be explained again.

It should be understood that, when the carriers which are used by first terminal device in a current time unit does not include the N2 carriers, only the portion of performing transmission power control, through P1, on carriers used for transmitting the first information for data reception status (which is abbreviated as P1 transmission power control), can be implemented; when the carriers which are used by first terminal device in the current time unit does not include the N1 carriers, only the portion of performing transmission power control, through P2, on carriers used for transmitting information other than the first information (which is abbreviated as P2 transmission power control), can be implemented; and when the carriers which are used by first terminal device in the current time unit include both the N1 carriers and the N2 carriers, both of the portions of P1 transmission power control and P2 transmission power control can be implemented.

It should be noted that the implementation of P1 transmission power control and the implementation of P2 transmission power control are two portions independent from each other, and the two portions can be implemented with no particular order. For example, P1 transmission power control can be implemented first, and P2 transmission power control can be implemented subsequently; or they can be implemented concurrently.

P2 may have a value as that in the following two cases.

Case (1), P2 is a difference between P and P1, namely, a sum of P2 and P1 is equal to P.

In case (1), in an implementation, the aforementioned P1 and/or P2 can be predefined.

Or, P1 and/or P2 can be determined by the first terminal device independently.

Or, P1 and/or P2 can be indicated by the network device. For example, the network device can send, to the first terminal device, indication information which is used for indicating P1 and/or P2. Correspondingly, the first terminal device can receive the indication information. For ease of distinguishing, the indication information which is used for indicating P1 and/or P2 is referred to as fifth indication information. As an example, the network device can, for example, send the aforementioned fifth indication information to the first terminal device through high-layer signaling, such as RRC signaling, a MAC CE, or the like. It should be noted that the manner in which the fifth indication information indicates P1 and/or P2 is not limited in the embodiment. For example, the fifth indication information can carry any information that can uniquely characterize P1 and/or P2, such as a specific value of P1 and/or P2, an index of P1 and/or P2, a percentage of P1 and/or P2 relative to P, or the like.

Or, P1 and/or P2 can be selected independently by the first terminal device from at least one piece of maximum transmission power allocation information indicated by the network device. For example, the network device can send at least one piece of maximum transmission power allocation information to the first terminal device, where each piece of maximum transmission power allocation information is used for indicating a group of P1 and/or P2. Correspondingly, the first terminal device can receive the at least one piece of maximum transmission power allocation information, and determine at least one group of P1 and/or P2 based on the at least one piece of maximum transmission power allocation information, and select one group of P1 and/or P2 that will be used from the at least one group of P1 and/or P2. As an example, the network device can, for example, send the aforementioned at least one piece of maximum transmission power allocation information to the first terminal device through high-layer signaling, such as RRC signaling, a MAC CE, or the like. It should be noted that the indication of the at least one piece of maximum transmission power allocation information is not limited in the embodiment, for example, possibly by carrying any information that can uniquely characterizing a group of P1 and/or P2, such as a specific value of each group of P1 and/or P2, an index of each group of P1 and/or P2, a percentage of each group of P1 and/or P2 relative to P, or the like.

Case (2), in a case where the sum of the transmission powers of the N1 carriers (which is denoted as a first power) is less than P1, P2 is a difference between P and the first power.

In case (2), when the first power is less than P1, it means that the sum of the transmission powers of the N1 carriers does not exceed the maximum transmission power allocated to the N1 carriers by the first terminal device, and there is also an unoccupied transmission power (namely, the difference between P and the first power). At this time, it may be unnecessary to adjust the transmission powers of the N1 carriers. When performing transmission power control on the N2 carriers, the difference between P and the first power can be a basis to perform transmission power control on the N2 carriers.

It should be noted that the transmission power control method as shown in FIG. 4 can be applied to a scenario that supports the HARQ feedback (such as NR V2X, or V2X of other communication systems); it can also be applied to a scenario of an uplink transmission with the network device.

It should be noted that in the embodiment, the aforementioned first terminal device can work under a single network type, for example, all of the N1 carriers and N2 carriers can be carriers used for transmitting channels/signals of a service of a first network type.

The aforementioned first terminal device can also work under both of the first network type and a second network type, namely, in a scenario of two network types which are assumed as the first network type and the second network type. When the first terminal device works under both of the first network type and the second network type, the transmission power control method under both of the first network type and the second network type can be adopted, for example, for transmission power control on the N1 carriers and/or transmission power control on the N1 carriers, which is described in the aforementioned FIG. 2 and FIG. 3 and thus will not be repeated here.

According to the method provided in the embodiments of the present disclosure, the maximum transmission power P of the first terminal device is divided into P1 and P2, where P1 is used for performing transmission power control on the carriers used for transmitting the first information for data reception status of the first terminal device, and P2 is used for performing transmission power control on the carriers used for transmitting information other than the first information. Through the transmission power control method, both the transmission of the first information and the transmission of other services are taken into account, thereby avoiding unnecessary retransmissions resulting from the discarding of the HARQ feedback, and reducing a waste of resources resulting from the unnecessary retransmissions.

In the following, the transmission power control methods according to the embodiments of the present disclosure will be explained for an illustrative purpose through a specific example.

As an example where the first terminal device works under an NR-LTE coexisting scenario, assuming that the first terminal device uses 9 carriers (CC0 to CC8) for channel/signal transmission in the current time unit, namely, N is equal to 9. The carrier CC0 to the carrier CC6 are used for channel/signal transmission of an NR service, and CC7 and CC8 are used for channel/signal transmission of an LTE service. A priority corresponding to each of the carriers, and a channel/signal type of a service being carried on each of the carriers are, for example, shown in Table 1 as follows.

TABLE 1

| Carrier | | Channel/signal type of a | Maximum transmission |
|---|---|---|---|
| Number | Priority | service being carried | power of carrier |
| CC0 | 3 | SSB | P_{CMAX, 0} |
| CC1 | 5 | PSFCH | P_{CMAX, 1} |
| CC2 | 7 | PSSCH | P_{CMAX, 2} |
| CC3 | 4 | PSCCH | P_{CMAX, 3} |
| CC4 | 4 | PSFCH | P_{CMAX, 4} |
| CC5 | 4 | PUCCH | P_{CMAX, 5} |
| CC6 | 5 | PSFCH | P_{CMAX, 6} |
| CC7 | 5 | PSCCH | P_{CMAX, 7} |
| CC8 | 4 | PSSCH | P_{CMAX, 8} |

In Table 1, a priority with a smaller value means a higher priority.

In the following examples, Examples 1 to 3 describe the implementation with regard to how to perform transmission power control on NR carriers when, the coexistence of LTE and NR is not supported by the first terminal device itself, or, although the coexistence of LTE and NR is supported, only channels/signals of an LTE service or channels/signals of an NR service can be transmitted in a same time unit. Example 4 and Example 5 describe the implementation with regard to how to perform transmission power control when, the coexistence of LTE and NR is supported by the first terminal device, and both channels/signals of an LTE service and channels/signals of an NR service can be transmitted in a same time unit.

Example 1, transmission power control based on a priority.

When the coexistence of LTE and NR is not supported by the first terminal device itself, or, although the coexistence of LTE and NR is supported, only channels/signals of an LTE service or channels/signals of an NR service can be transmitted in a same time unit, regarding the 7 NR carriers CC0 to CC6, transmission power control can be performed based on the priorities. For transmission power control on a certain carrier, the following method is adopted: reducing the transmission power, and after reducing the transmission power, if a sum of transmission powers of the N carriers is still greater than the maximum transmission power P of the first terminal device, discarding a service for transmission on the carrier.

An example is as follows.

Based on a priority order from low to high, adjust the transmission power P P_{CMAX,2} of the carrier CC2 first. After adjusting the transmission power of carrier CC2, if the sum of the transmission powers of the 7 carriers is less than or equal to the maximum transmission power P of the first terminal device, terminate transmission power control, and perform no transmission power adjustment on the rest of the carriers. If the sum of the transmission powers of the 7 carriers is still greater than the maximum transmission power P of the first terminal device, discard the service for transmission on the carrier CC2. Namely, set the transmission power of the carrier CC2 to 0.

After discarding the service for transmission on the carrier CC2, if the sum of the transmission powers of the 7 carriers is less than or equal to the maximum transmission power P of the first terminal device, terminate transmission power control, and perform no transmission power adjustment on the rest of the carriers. If the sum of the transmission powers of the 7 carriers is still greater than the maximum transmission power P of the first terminal device, adjustment is made to an NR carrier with a priority value of 5. Since the priority values of both of the carrier CC1 and the carrier CC6 are 5, and the channels they carry are the same (namely, PSFCHs), the first terminal device determines independently which carrier is specifically prioritized for transmission power adjustment. Take an example where adjustment is made to CC1 first and then adjustment is made to the carrier CC6, the adjustment method of CC2 can be used for processing CC1 and CC6.

After discarding the services for transmission on the carriers CC1 and CC6, if the sum of the transmission powers of the 7 carriers is still greater than the maximum transmission power P of the first terminal device, further adjust an NR carrier of a next priority, namely, an NR carrier with a priority value of 4. With reference to Table 1, it can be seen that there are a total of 3 NR carriers with a priority value of 4, and each of the NR carriers carries a different channel, thus, the 3 carriers can be adjusted sequentially based on a first adjustment order determined based on the channels carried by the 3 NR carriers with a priority value of 4.

Assuming that the first adjustment order for NR carriers with a priority value of 4 is to adjust a PSSCH first, then a PUCCH, and a PSFCH lastly, the first terminal device can adjust, based on the first adjustment order, the carrier CC3 for transmitting a PSSCH, then adjust the carrier CC5 for transmitting a PUCCH, and lastly, adjust the carrier CC4 for transmitting a PSFCH. The adjustment method of CC2 can be used for processing CC3, CC4, and CC5.

After discarding the services for transmission on the carriers CC3, CC4, and CC5, if the sum of the transmission powers of the 7 carriers is still greater than the maximum transmission power P of the first terminal device, further adjust a carrier of a next priority, namely, the carrier CC0 with a priority value of 3. Namely, CC0 of a highest priority is adjusted lastly.

In addition, the foregoing transmission power control process provides an order. If the power constraint is met at a certain step, the subsequent process for transmission power control will not be executed.

It should be noted that, the foregoing transmission power control process merely provides an order, for an illustrative purpose, in which transmission power adjustment is performed when transmission power control is being performed on carriers based on priorities, however, not all carriers need transmission power adjustment. In the foregoing transmission power control process, after adjusting the transmission power of a certain carrier or discarding a service for transmission, if such a constraint condition is met that the sum of the transmission powers of the 7 carriers is less than or equal to the maximum transmission power P of the first terminal device, it may be unnecessary to perform transmission power control on the subsequently carriers.

It should be noted that, in general, it is unlikely for occurrence of such a situation that the maximum transmission power of the first terminal device cannot support the transmission on one carrier, namely, it is unlikely for occurrence of such a situation that the maximum transmission power of the first terminal device is less than the maximum transmission power of the carrier, so usually, the case where “CC0 of a highest priority is adjusted lastly based on the priorities” will not arise.

In addition, although description in the forgoing examples is made in a manner of, for each carrier, reducing the transmission power first, and after reducing the transmission power, if the sum of the transmission power of the 7 carriers is still greater than the maximum transmission power P of the first terminal device, discarding a service for transmission on the carrier, it should be understood that different adjustment methods can be applied to each carrier, or a same adjustment method can be applied to carriers of a same priority. For example, transmission power adjustment can be performed on CC2 by using the method of reducing the transmission power, and transmission power adjustment is performed on CC1 and CC6 by using the method of reducing first and discarding subsequently.

In the embodiment, the first terminal device can perform transmission power adjustment, based on a priority of a service for transmission on each of the carriers, and for a same priority, based on an adjustment order related to a type of a channel/signal for transmission on the carriers. The transmission power control method, takes the differences between various channels and between priorities of services to be transmitted into full consideration, in addition to achieving transmission power control in NR V2X carrier aggregation, it can guarantee that the transmission of a more important service, and a more important channel/signal is prioritized.

Example 2, transmission power control based on a transmission power adjustment weight of each of the carriers.

When the coexistence of LTE and NR is not supported by the first terminal device itself, or, although the coexistence of LTE and NR is supported, only channels/signals of an LTE service or channels/signals of an NR service can be transmitted in a same time unit, regarding the NR carriers, transmission power control can be performed based on a transmission power adjustment weight of each of the carriers. For example, the aforementioned formula (2) can be used to perform transmission power control on the carrier CC0 to the carrier CC6, such that the sum of the transmission powers of the 7 carriers after adjustment is less than the maximum transmission power of the first terminal device.

Take an example where a transmission power adjustment weight of a carrier can be related to a priority of a service to be transmitted, and a type of a channel/signal to be transmitted on the carrier. In this implementation, CC1 and CC6 have a same priority and transmit a same channel, therefore, CC1 and CC6 can have a same transmission power adjustment weight. Similarly, CC3 and CC5 can have a same transmission power adjustment weight, while other carriers including CC0, CC2, and CC4 have transmission power adjustment weights that are different from each other.

In the embodiment, a transmission power adjustment weight can be configured for each of the carriers based on a difference between various channels and priorities of services to be transmitted, so as to perform transmission power adjustment. Through the method, in addition to achieving power control in NR V2X carrier aggregation, it is permitted that services on all of the carriers can be transmitted, thereby, a requirement can be met when the services on all of the carriers must be transmitted. Namely, the transmission power control method based on the embodiment is applicable to an application scenario where the services on all of the carriers must be transmitted.

Example 3, transmission power control based on a transmission power adjustment weight of each of the carriers.

When the coexistence of LTE and NR is not supported by the first terminal device itself, or, although the coexistence of LTE and NR is supported, only channels/signals of an LTE service or channels/signals of an NR service can be transmitted in a same time unit, regarding the NR carriers from CC0 to CC6, transmission power control can be performed, for example, using the following method:

dividing the maximum transmission power P of the first terminal device into P1 and P2, to perform transmission power control independently, through P1, on carriers in the carrier CC0 to the carrier CC6 that are used for transmitting first information for data reception status, and to perform transmission power control independently, through P2, on carriers in the carrier CC0 to the carrier CC6 that are used for transmitting information other than the first information.

Take Table 1 as an example, CC1, CC4, and CC6 in CC0 to CC6 are the carriers used for transmitting the first information, and CC0, CC2, CC3, and CC5 are the carriers used for transmitting information other than the first information.

For example, it can be defined that a parameter X∈[0,1], P1=XP is used for transmission power control for CC1, CC4, and CC6, and P2=P-P1 is used for transmission power control for carriers CC0, CC2, CC3, and CC5.

For transmission power control for CC1, CC4, and CC6, which are the carriers used for transmitting the first information, the method according to the aforementioned Example 1 or Example 2 can be adopted to perform transmission power control.

For CC0, CC2, CC3, and CC5, which are the carriers that are not used for transmitting the first information, the transmission power control method for LTE V2X can still be adopted, or the method according to the aforementioned Example 1 or Example 2 can also be adopted to perform transmission power control.

In the embodiment, the maximum transmission power P of the first terminal device is divided into P1 and P2, where P1 is used for performing transmission power control on the carriers used for transmitting the first information for data reception status of the first terminal device, and P2 is used for performing transmission power control on the carriers used for transmitting information other than the first information. Through the transmission power control method, in addition to achieving power control in NR V2X carrier aggregation, both the transmission of the first information and the transmission of other services are taken into account, thereby avoiding unnecessary retransmissions resulting from the discarding of the HARQ feedback, and reducing a waste of resources resulting from the unnecessary retransmissions.

Example 4, perform joint power control on the carriers when the coexistence of LTE and NR is supported by the first terminal device, and both channels/signals of an LTE service and channels/signals of an NR service can be transmitted in a same time unit (Namely, in a process of determining the priorities, the carriers used for channel/signal transmission of an LTE service and the carriers used for channel/signal transmission of an NR service are combined to determine the priorities of the services to be transmitted on these carriers. Namely, processing the priorities of LTE and NR as equivalents, such that the priorities of the 8 services in LTE from high to low are in a one-to-one correspondence with the priorities of the 8 services in NR from high to low, regardless of considering whether a carrier is used for channel/signal transmission of an LTE service or for channel/signal transmission of an NR service).

For example, the method as shown in Example 1 which is based on priorities can be adopted to perform transmission power control, the method as shown in Example 2 which is based on a transmission power adjustment weight of each of the carriers can also be adopted to perform transmission power control, or, adopted is what shown in Example 3 where the maximum transmission power P of the first terminal device is divided into P1 and P2, and independent transmission power control is performed respectively on the carriers used for transmitting the first information, and the carriers used for transmitting information other than the first information.

Take an example where transmission power control is performed using the method as shown in Example 1 which is based on priorities, an order of transmission power control on CC0 to CC8 can be as follows:
CC2;
CC7;
CC1 and CC6;
CC3, CC5 and CC8;
CC4;
CC0.

It should be noted that, for multiple carriers of a same priority, adjustment can be performed based on a first adjustment order which is determined based on types of channels/signals to be transmitted on multiple carriers. For multiple carriers which have a same priority and are used for transmitting channels/signals of a same type, the first terminal device can determine independently which carrier is prioritized for power adjustment, namely, the first terminal device determines sequential orders of the multiple carriers in the first adjustment order.

The embodiment, which corresponds to a scenario with the coexistence of LTE and NR, can solve effectively a problem of how to perform transmission power control when a carrier used for transmitting an LTE service and a carrier used for transmitting an NR service are transmitted simultaneously.

Example 5, transmission power control based on a specific order when the coexistence of LTE and NR is supported by the first terminal device, and both channels/signals of an LTE service and channels/signals of an NR service can be transmitted in a same time unit.

In an example, an NR service is prioritized for transmission, or an LTE service is prioritized for transmission, which can be determined based on configuration, or a protocol, or predetermination. For example, the overall priority of NR services is higher than the overall priority of LTE services, in other words, NR services are core services and LTE services are extended services.

For example, when an NR service is prioritized for transmission, the method as shown in Example 1 which is based on priorities can be adopted to perform transmission power control, the method as shown in Example 2 which is based on a transmission power adjustment weight of each of the carriers can also be adopted to perform transmission power control, or, adopted is what shown in Example 3 where the maximum transmission power P of the first terminal device is divided into P1 and P2, and independent transmission power control is performed respectively on the carriers used for transmitting the first information of an NR service, and the carriers used for transmitting information of an NR service other than the first information.

Take an example where transmission power control is performed through the method as shown in Example 1 which is based on priorities, when a channel/signal of an NR service is prioritized for transmission, an order of transmission power control on CC0 to CC8 can be as follows:
CC7; //an LTE carrier
CC8; //an LTE carrier
CC2;
CC1, CC6;
CC3, CC5;
CC4;
CC0.

It should be noted that, for multiple carriers of a same priority, adjustment can be performed based on a first adjustment order which is determined based on types of channels/signals to be transmitted on multiple carriers. For multiple carriers which have a same priority and are used for transmitting channels/signals of a same type, the terminal first device can determine independently which carrier is prioritized for power control, namely, the first terminal device determines sequential orders of the multiple carriers in the first adjustment order.

The embodiment corresponds to a scenario with the coexistence of LTE and NR. When priorities of services of one network type is collectively higher than priorities of services of the other network type, in other words, when services of one network type are core services and services of the other network type are extended services, it can be guaranteed that the transmission of services of a network type which has a higher priority is prioritized, so as to guarantee that the transmission of a more important service is prioritized.

In the above, the methods according to the embodiments of the present disclosure are specified in detail in conjunction with FIG. 2 to FIG. 4. In the following, the apparatuses according to the embodiments of the present disclosure are specified in detail in conjunction with FIG. 5 to FIG. 8.

FIG. 5 is a schematic structural diagram of a communication apparatus according to an embodiment of the present disclosure. It can be understood that the communication apparatus can implement the operations or steps in the aforementioned method embodiments as shown in FIG. 2 corresponding to the first terminal device. The communication apparatus can be the first terminal device or a component that can be configured in the first terminal device, such as a chip. As shown in FIG. 5, the communication apparatus can include: a processing module 11 and a transmitting module 12. In an implementation, the communication apparatus can further include: a receiving module 13. In an implementation, the receiving module 13 and the transmitting module 12 can be integrated into a transceiver module, or they can be set separately.

The processing module 11 is configured to, when a sum of transmission powers of N carriers is greater than a maximum transmission power of the first terminal device, adjust a transmission power sequentially according to a priority order from low to high of services to be transmitted on the N carriers, until a sum of transmission powers of the N carriers after adjustment is less than or equal to the maximum transmission power, where carriers, out of the N carriers, for corresponding services having a same priority are subjected to transmission power adjustment based on a first adjustment order, the first adjustment order is related to a type of a channel/signal to be transmitted on the carriers for the corresponding services having the same priority; some or all of the N carriers are used for communication with a second terminal device; and N is an integer greater than or equal to 2.

The transmitting module 12 is configured to perform, with use of adjusted respective transmission powers of M carriers, channel/signal transmission simultaneously on the M carriers, where the M carriers are carriers, subjected to transmission power adjustment out of the N carriers, with transmission powers not being 0, and M is an integer greater than 0 and less than or equal to N.

In an implementation, the first adjustment order is predefined. Or, the receiving module 13 is configured to receive, from a network device, indication information which is used for indicating the first adjustment order; or, the receiving module 13 is configured to receive, from the network device, indication information which is used for indicating at least one adjustment order, where the at least one adjustment order includes the first adjustment order.

In an implementation, the processing module 11 is specifically configured to, reduce a transmission power of a carrier; or, discard a service to be transmitted on the carrier; or, after reducing the transmission power of the carrier, if a sum of transmission powers of the N carriers is still greater than the maximum transmission power, discard the service to be transmitted on the carrier.

In an implementation, the N carriers include X carriers for channel/signal transmission of a service of a first network type, and Y carriers for channel/signal transmission of a service of a second network type; where X and Y are both positive integers, and a sum of X and Y is equal to N. The receiving module 13 is further configured to receive configuration information, where the configuration information is used for configuring priorities of the service of the first network type and the service of the second network type; or, the processing module 11 is further configured to determine the priorities of the service of the first network type and the service of the second network type independently; or, the priorities of the service of the first network type and the service of the second network type are predefined.

In an implementation, the N carriers include a carrier for transmitting first information, where the first information is used to feedback data reception status of the first terminal device.

In an implementation, the aforementioned communication apparatus can further include at least one storage module which can include data and/or an instruction, and another module in the communication apparatus (such as the processing module 11, the transmitting module 12, or the receiving module 13) can read the data and/or the instruction in the storage module to implement a corresponding method.

The communication apparatus according to the embodiment can perform the actions of the first terminal device in the aforementioned method embodiment corresponding to FIG. 2. The implementation principle and technical effect thereof are similar, which will not be repeated here.

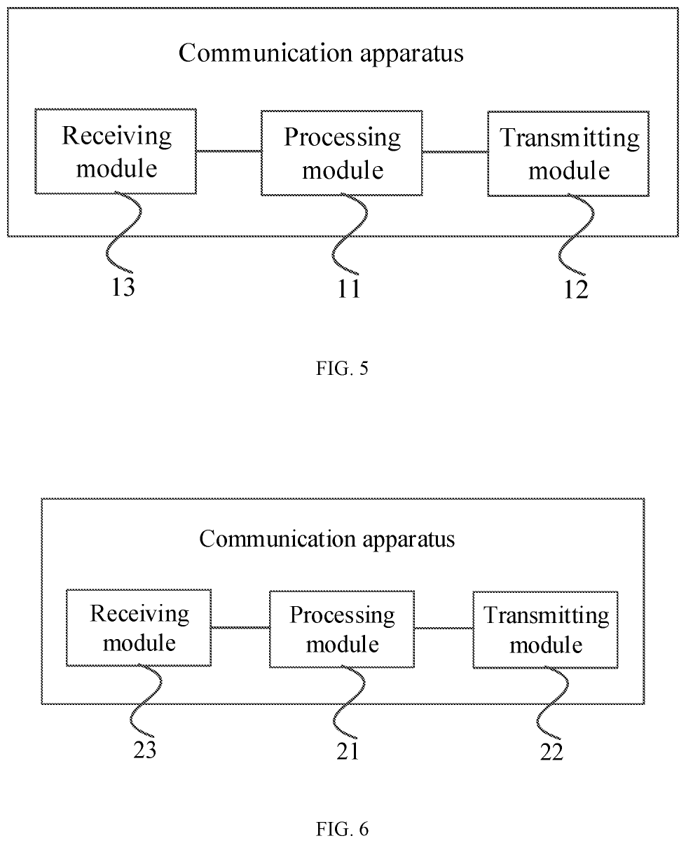

FIG. 6 is another schematic structural diagram of a communication apparatus according to an embodiment of the present disclosure. It can be understood that the communication apparatus can implement the operations or steps in the aforementioned method embodiments as shown in FIG. 3 corresponding to the first terminal device. The communication apparatus can be the first terminal device or a component that can be configured in the first terminal device, such as a chip. As shown in FIG. 6, the communication apparatus can include: a processing module 21 and a transmitting module 22. In an implementation, the communication apparatus can further include: a receiving module 23. In an implementation, the receiving module 23 and the transmitting module 22 can be integrated into a transceiver module, or they can be set separately.

The processing module 21 is configured to, when a sum of transmission powers of N carriers is greater than a maximum transmission power of the first terminal device, adjust a transmission power of each of the carriers according to a transmission power adjustment weight of each of the carriers, so that a sum of transmission powers of the N carriers after adjustment is less than or equal to the maximum transmission power, where N is an integer greater than or equal to 2.

The transmitting module 22 is configured to perform, with use of adjusted respective transmission powers of M carriers, channel/signal transmission simultaneously on the M carriers, where the M carriers are carriers, subjected to transmission power adjustment out of the N carriers, with transmission powers not being 0, and M is an integer greater than 0 and less than or equal to N.

In an implementation, in the N carriers, carriers satisfying a first condition have a same transmission power adjustment weight, where the first condition includes at least one of the following: being used for transmitting services of a same priority, or being used for transmitting channels/signals of a same type.

In an implementation, transmission power adjustment weights of the N carriers are predefined; or, the receiving module 23 is configured to receive, from a network device, indication information which is used for indicating the transmission power adjustment weights of the N carriers; or, the processing module 21 is further configured to determine the transmission power adjustment weights of the N carriers independently.

In an implementation, the N carriers include X carriers for channel/signal transmission of a service of a first network type, and Y carriers for channel/signal transmission of a service of a second network type; where X and Y are both positive integers, and a sum of X and Y is equal to N. The receiving module 23 is further configured to receive configuration information, where the configuration information is used for configuring priorities of the service of the first network type and the service of the second network type; or, the processing module 21 is further configured to determine the priorities of the service of the first network type and the service of the second network type independently; or, the priorities of the service of the first network type and the service of the second network type are predefined.

In an implementation, some or all of the N carriers are used for communication with a second terminal device.

In an implementation, the N carriers include a carrier for transmitting first information, where the first information is used to feedback data reception status of the first terminal device.

In an implementation, the aforementioned communication apparatus can further include at least one storage module which can include data and/or an instruction, and another module in the communication apparatus (such as the processing module 21, the transmitting module 22, or the receiving module 23) can read the data and/or the instruction in the storage module to implement a corresponding method.

The communication apparatus according to the embodiment can perform the actions of the first terminal device in the aforementioned method embodiment corresponding to FIG. 3. The implementation principle and technical effect thereof are similar, which will not be repeated here.

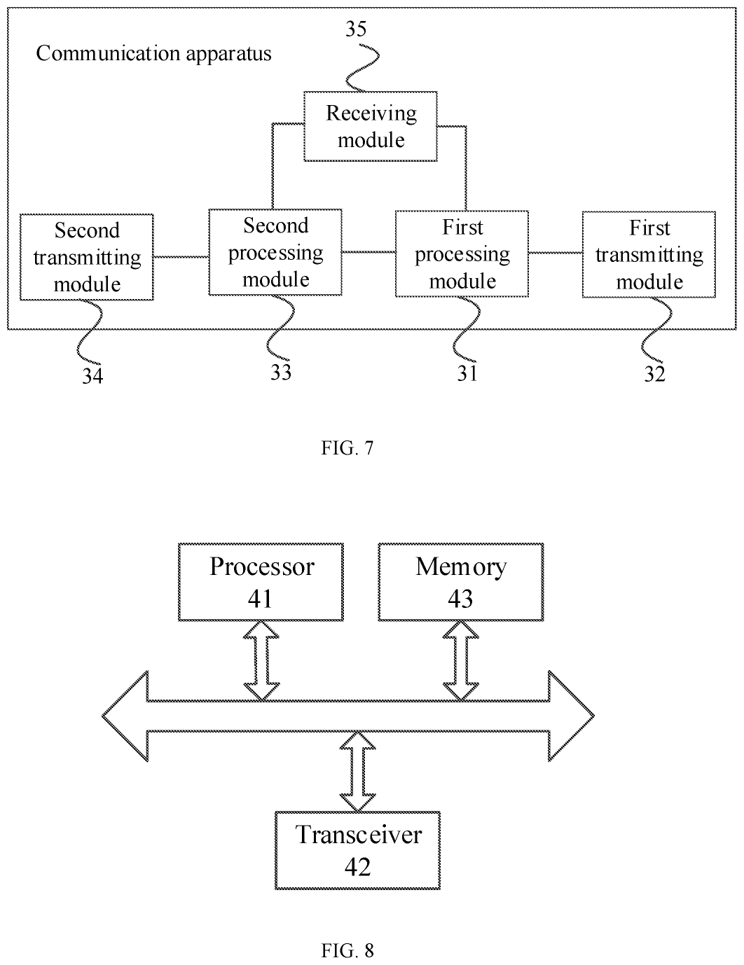

FIG. 7 is yet another schematic structural diagram of a communication apparatus according to an embodiment of the present disclosure. It can be understood that the communication apparatus can implement the operations or steps in the aforementioned method embodiments as shown in FIG. 4 corresponding to the first terminal device. The communication apparatus can be the first terminal device or a component that can be configured in the first terminal device, such as a chip. As shown in FIG. 7, the communication apparatus can include: a first processing module 31 and a first transmitting module 32, and/or, a second processing module 33 and a second transmitting module 34. In an implementation, the communication apparatus can further include: a receiving module 35. In an implementation, the first transmitting module 32, the second transmitting module 34 and the receiving module 35 can be integrated into a transceiver module, or they can be set separately.

The first processing module 31 is configured to, when a sum of transmission powers of N1 carriers is greater than P1, adjust a transmission power of one or more carriers of the N1 carriers, so that a sum of transmission powers of the N1 carriers after adjustment is less than or equal to P1, where all of the N1 carriers are carriers used for transmitting first information, and the first information is used to feedback data reception status of the first terminal device; P1 is a maximum transmission power allocated, from a maximum transmission power P of the first terminal device, to the N1 carriers; and N1 is an integer greater than or equal to 1; and

the first transmitting module 32 is configured to transmit simultaneously, with use of adjusted respective transmission powers of M1 carriers, the first information on the M1 carriers, where the M1 carriers are carriers, subjected to transmission power adjustment out of the N1 carriers, with transmission powers not being 0, and M1 is an integer greater than 0 and less than or equal to N1;

and/or,

the second processing module 33 is configured to, when a sum of transmission powers of N2 carriers is greater than P2, adjust a transmission power of one or more carriers of the N2 carriers, so that a sum of transmission powers of the N2 carriers after adjustment is less than or equal to P2, where all of the N2 carriers are used for transmitting information other than the first information; P2 is a maximum transmission power allocated, from the maximum transmission power P of the first terminal device, to the N2 carriers, and N2 is an integer greater than or equal to 1; and a sum of P1 and P2 is equal to P, or, under a circumstance that a first power is less than P1, P2 is a difference between P and the first power, where the first power is a sum of transmission powers of the N1 carriers; and

the second transmitting module 34 is configured to transmit simultaneously, with use of adjusted respective transmission powers of M2 carriers, information other than the first information on the M2 carriers, where the M2 carriers are carriers, subjected to transmission power adjustment out of the N2 carriers, with transmission powers not being 0, and M2 is an integer greater than 0 and less than or equal to N2.

In an implementation, P1 and/or P2 is predefined; or, the receiving module 35 is configured to receive, from a network device, indication information which is used for indicating P1 and/or P2; or, the receiving module 35 is configured to receive, from the network device, at least one piece of maximum transmission power allocation information, where each piece of maximum transmission power allocation information is used for indicating a group of P1 and/or P2.

In an implementation, the first processing module 31 is specifically configured to adjust a transmission power sequentially based on a priority order from low to high of services to be transmitted on the N1 carriers, until a sum of transmission powers of the N1 carriers after adjustment is less than or equal to P1; or, adjust, based on a transmission power adjustment weight of each of the N1 carriers, the transmission power of each of the carriers.

In an implementation, the second processing module 33 is specifically configured to: adjust a transmission power sequentially based on a priority order from low to high of services to be transmitted on the N2 carriers, until a sum of transmission power of the N2 carriers after adjustment is less than or equal to P2; or, adjust, based on a transmission power adjustment weight of each of the N2 carriers, the transmission power of each of the carriers.

In an implementation, the aforementioned communication apparatus can further include at least one storage module which can include data and/or an instruction, and another module in the communication apparatus (such as the first processing module 31, the first transmitting module 32, the second processing module 33, the second transmitting module 34 or the receiving module 35) can read the data and/or the instruction in the storage module to implement a corresponding method.

It should be noted that, it should be understood that the transmitting module in the foregoing embodiments can be practically implemented as a transmitter, and the receiving module can be practically implemented as a receiver, or, the transmitting module and the receiving module are implemented through a transceiver, or the transmitting module and the receiving module are implemented through a communication port. The processing module can be implemented in a form of software which is called by a processing unit; or it can be implemented in a form of hardware. For example, the processing module can be at least one processing element that is set independently, or it can be implemented as being integrated into a chip of the aforementioned apparatus, or, it can also be stored in a memory of the aforementioned apparatus in a form of a program code, which can be called by a certain processing element to execute a function of the aforementioned apparatus. In addition, all or part of these modules can be integrated together or implemented independently. The processing element as mentioned here can be an integrated circuit with a signal processing capability. In terms of implementation, each of the steps of the foregoing method or each of the foregoing modules can be accomplished by an integrated logic circuit of hardware in a processor element or an instruction in the form of software.

FIG. 8 is still another schematic structural diagram of a communication apparatus according to an embodiment of the present disclosure. As shown in FIG. 8, the communication apparatus can include: a processor 41, a transceiver 42 and a memory 43. The processor 41, the transceiver 42, and the memory 43 communicate with each other through an internal connection pathway, the memory 43 is configured to store an instruction, and the processor 41 is configured to execute the instruction stored in the memory 43 to control the transceiver 42 to transmit a channel/signal and/or to receive a channel/signal.

It should be understood that the communication apparatus can correspond to the first terminal device in the foregoing method embodiments as shown in FIG. 2 to FIG. 4, and can be used to execute various steps and/or processes executed by the first terminal device in the foregoing method embodiments as shown in FIG. 2 to FIG. 4. In an implementation, the memory 43 can include a read-only memory and a random access memory, and provide an instruction and data to the processor 41. A portion of the memory 43 can further include a non-volatile random access memory. The memory 43 can be a separate element, or be integrated into the processor 41. The processor 41 can be configured to execute the instruction stored in the memory 43, and when the processor 41 executes the instruction stored in the memory, the processor 41 is configured to execute the various steps and/or processes in the foregoing method embodiments as shown in FIG. 2 to FIG. 4.

In an implementation, the communication apparatus is the first terminal device in the embodiment as shown in FIG. 2, or the first terminal device in the embodiment as shown in FIG. 3, or the first terminal device in the embodiment as shown in FIG. 4.

The transceiver 42 can include a transmitter and a receiver. The transceiver 42 may further include an antenna, where the antenna may be singular or plural in number. The processor 41 and the memory 43 can be elements which are integrated into a different chip from the transceiver 42. For example, the processor 41 and the memory 43 can be integrated into a baseband chip, and the transceiver 42 can be integrated into an RF chip. The processor 41 and the memory 43 can also be elements which are integrated into a same chip as the transceiver 42. It is not limited in the present disclosure in this regard.

In an implementation, the communication apparatus is a component configured in the first terminal device, such as a chip, a chip system, etc.

The transceiver 42 can also be a communication interface, such as an input/output interface, a circuit, or the like. The transceiver 42, and the processor 41 and the memory 43 can be all integrated into a same chip, for example, a baseband chip.

The present disclosure further provides a communication apparatus, including at least one processor, where the at least one processor is configured to execute a computer program stored in a memory, to enable the communication apparatus to implement the methods implemented by the first terminal device in the foregoing method embodiments.

An embodiment of the present disclosure further provides a communication apparatus, including a processor and an input/output interface. The input/output interface is coupled to the processor. The input/output interface is configured to input and/or output information. The information includes at least one item of an instruction and data. The processor is configured to execute a computer program to enable the communication apparatus to implement the methods implemented by the first terminal device in the foregoing method embodiments.

An embodiment of the present disclosure further provides a communication apparatus, including a processor and a memory. The memory is configured to store a computer program, and the processor is configured to call and run the computer program from the memory to enable the communication apparatus to implement the methods implemented by the first terminal device in the foregoing method embodiments.

It should be understood that the foregoing communication apparatus can be one or more chips. For example, the communication apparatus can be a field programmable gate array (field programmable gate array, FPGA), an application specific integrated circuit (application specific integrated circuit, ASIC), a system on chip (system on chip, SoC), a central processor unit (central processor unit, CPU), or a network processor (network processor, NP), a digital signal processor (digital signal processor, DSP), a micro controller unit (micro controller unit, MCU), a programmable logic device (programmable logic device, PLD), or other integrated chips.

In terms of implementation, each of the steps of the foregoing method can be accomplished by an integrated logic circuit of hardware in a processor or an instruction in the form of software. The steps of the method disclosed in the embodiments of the present disclosure may be directly embodied as being executed by a processor with hardware, or executed by a processor with a combination of hardware and software modules. A software module may be in a storage medium well-known in the art, such as a random access memory, a flash memory, a read-only memory, a programmable read-only memory, an electrically erasable programmable memory, a register, or the like. The storage medium is in a memory, and the processor accesses the information in the memory and executes the steps of the foregoing methods in combination with its hardware. For brevity, no elaboration is made here.

It should be noted that the processor in the embodiments of the present disclosure can be an integrated circuit chip with a signal processing capability. In terms of implementation, each of the steps of the foregoing method embodiment can be accomplished by an integrated logic circuit of hardware in a processor or an instruction in the form of software. The aforementioned processor can be a general purpose processor, a digital signal processor (DSP), an application specific integrated circuit (ASIC), a field programmable gate array (FPGA) or a further programmable logic device, a discrete gate or a transistor logic device, a discrete hardware component or the like, which implements or executes respective methods, steps and logic diagrams disclosed in the embodiments of the present disclosure. A general purpose processor can be a microprocessor, or can be any conventional processor or the like. The steps of the method disclosed in the embodiments of the present disclosure may be directly executed by a decoding processor with hardware, or executed by a decoding processor with a combination of hardware and software modules. A software module may be in a storage medium well-known in the art, such as a random access memory, a flash memory, a read-only memory, a programmable read-only memory, an electrically erasable programmable memory, a register, or the like. The storage medium is in a memory, and the processor accesses the information in the memory and executes the steps of the foregoing methods in combination with its hardware.

It should be understood that the memory in the embodiments of the present disclosure may be a volatile memory or a non-volatile memory, or may include both a volatile memory and a non-volatile memory. The non-volatile memory may be a read-only memory (read-only memory, ROM), a programmable ROM (programmable ROM, PROM), an erasable PROM (erasable PROM, EPROM), an electrically EPROM (electrically EPROM, EEPROM) or a flash memory. The volatile memory may be a random access memory (random access memory, RAM) which serves as an external high speed cache. Through description being illustrative but not limiting, many types of RAMs are available, such as a static RAM (static RAM, SRAM), a dynamic RAM (dynamic RAM, DRAM), a synchronous DRAM (synchronous DRAM, SDRAM), a double data rate SDRAM (double data rate SDRAM, DDR SDRAM), an enhanced SDRAM (enhanced SDRAM, ESDRAM), a synchlink DRAM (synchlink DRAM, SLDRAM), a direct rambus RAM (direct rambus RAM, DR RAM) or the like. It should be noted that the memory described herein is intended to include, but not limited to, these and any other suitable types of memories.

According to the methods provided in the embodiments of the present disclosure, the present disclosure further provides a computer program product, including a computer program which, when running on a computer, enables the computer to implement the method implemented by the first terminal device in the embodiment as shown in FIG. 2, FIG. 3, or FIG. 4.

According to the methods provided in the embodiments of the present disclosure, the present disclosure further provides a computer readable storage medium, storing thereon a computer program which, when running on a computer, enables the computer to implement the method implemented by the first terminal device in the embodiment as shown in FIG. 2, FIG. 3, or FIG. 4.

According to the methods provided in the embodiments of the present disclosure, the present disclosure further provides a communication system, where the communication system includes the first terminal device, the second terminal device and the network device as described above.

The present application provides a communication method and apparatus, a storage medium, and a program product, which are used for implementing transmission power control in NR V2X.

In a first aspect, the present disclosure provides a communication method, being applied to a first terminal device, where the method includes:
when a sum of transmission powers of N carriers is greater than a maximum transmission power of the first terminal device, adjusting a transmission power sequentially according to a priority order from low to high of services to be transmitted on the N carriers, until a sum of transmission powers of the N carriers after adjustment is less than or equal to the maximum transmission power, where carriers, out of the N carriers, for corresponding services having a same priority are subjected to transmission power adjustment based on a first adjustment order, the first adjustment order is related to a type of a channel/signal to be transmitted on the carriers for the corresponding services having the same priority; some or all of the N carriers are used for communication with a second terminal device; and N is an integer greater than or equal to 2; and
performing, with use of adjusted respective transmission powers of M carriers, channel/signal transmission on the M carriers simultaneously, where the M carriers are carriers, subjected to transmission power adjustment out of the N carriers, with transmission powers not being 0, and M is an integer greater than 0 and less than or equal to N.

In an implementation, transmission power adjustment weights of the N carriers are predefined.

In an implementation, the method further includes:
receiving, from a network device, indication information which is used for indicating the first adjustment order; or,
receiving, from the network device, indication information which is used for indicating at least one adjustment order, where the at least one adjustment order includes the first adjustment order.

In an implementation, adjusting the transmission power includes:
reducing a transmission power of a carrier; or,
discarding a service to be transmitted on the carrier; or,
after reducing the transmission power of the carrier, if the sum of the transmission powers of the N carriers is still greater than the maximum transmission power, discarding the service to be transmitted on the carrier.

In an implementation, the N carriers include X carriers for channel/signal transmission of a service of a first network type, and Y carriers for channel/signal transmission of a service of a second network type; where X and Y are both positive integers, and a sum of X and Y is equal to N; the method further includes:
receiving configuration information, where the configuration information is used for configuring priorities of the service of the first network type and the service of the second network type; or
determining the priorities of the service of the first network type and the service of the second network type independently.

In an implementation, the priorities of the service of the first network type and the service of the second network type are predefined.

In an implementation, the N carriers include a carrier for transmitting first information, where the first information is used to feedback data reception status of the first terminal device.

In a second aspect, the present disclosure provides a communication method, being applied to a first terminal device, where the method includes:
when a sum of transmission powers of N carriers is greater than a maximum transmission power of the first terminal device, adjusting a transmission power of each of the carriers based on a transmission power adjustment weight of each of the carriers, so that a sum of transmission powers of the N carriers after adjustment is less than or equal to the maximum transmission power, where N is an integer greater than or equal to 2; and
performing, with use of adjusted respective transmission powers of M carriers, channel/signal transmission on the M carriers simultaneously, where the M carriers are carriers, subjected to transmission power adjustment out of the N carriers, with transmission powers not being 0, and M is an integer greater than 0 and less than or equal to N.

In an implementation, in the N carriers, carriers satisfying a first condition have a same transmission power adjustment weight, where the first condition includes at least one of the following:
being used for transmitting services of a same priority, or being used for transmitting channels/signals of a same type.

In an implementation, the N carriers include X carriers for channel/signal transmission of a service of a first network type, and Y carriers for channel/signal transmission of a service of a second network type; where X and Y are both positive integers, and a sum of X and Y is equal to N; the method further includes:
receiving configuration information, where the configuration information is used for configuring priorities of the service of the first network type and the service of the second network type; or
determining the priorities of the service of the first network type and the service of the second network type independently.

In an implementation, the priorities of the service of the first network type and the service of the second network type are predefined.

In an implementation, transmission power adjustment weights of the N carriers are predefined.

In an implementation, the method further includes:
receiving, from a network device, indication information which is used for indicating transmission power adjustment weights of the N carriers; or,
determining the transmission power adjustment weights of the N carriers independently.

In an implementation, some or all of the N carriers are used for communication with a second terminal device.

In an implementation, the N carriers include a carrier for transmitting first information, where the first information is used to feedback data reception status of the first terminal device.

In a third aspect, the present disclosure provides a communication method, being applied to a first terminal device, where the method includes:
when a sum of transmission powers of N1 carriers is greater than P1, adjusting a transmission power of one or more carriers of the N1 carriers, so that a sum of transmission powers of the N1 carriers after adjustment is less than or equal to P1, where all of the N1 carriers are carriers used for transmitting first information, and the first information is used to feedback data reception status of the terminal device; P1 is a maximum transmission power allocated, from a maximum transmission power P of the first terminal device, to the N1 carriers; and N1 is an integer greater than or equal to 1; and
transmitting simultaneously, with use of adjusted respective transmission powers of M1 carriers, the first information on the M1 carriers, where the M1 carriers are carriers, subjected to transmission power adjustment out of the N1 carriers, with transmission powers not being 0, and M1 is an integer greater than 0 and less than or equal to N1;
and/or,
when a sum of transmission powers of N2 carriers is greater than P2, adjusting a transmission power of one or more carriers of the N2 carriers, so that a sum of transmission powers of the N2 carriers after adjustment is less than or equal to P2, where all of the N2 carriers are used for transmitting information other than the first information; P2 is a maximum transmission power allocated, from the maximum transmission power P of the first terminal device, to the N2 carriers, and N2 is an integer greater than or equal to 1; and a sum of P1 and P2 is equal to P, or, under a circumstance that a first power is less than P1, P2 is a difference between P and the first power, where the first power is a sum of transmission powers of the N1 carriers; and
transmitting simultaneously, with use of adjusted respective transmission powers of M2 carriers, information other than the first information on the M2 carriers, where the M2 carriers are carriers, subjected to transmission power adjustment out of the N2 carriers, with transmission powers not being 0, and M2 is an integer greater than 0 and less than or equal to N2.

In an implementation, P1 and/or P2 is predefined.

In an implementation, the method further includes:
receiving, from a network device, indication information which is used for indicating P1 and/or P2; or,
receiving, from the network device, at least one piece of maximum transmission power allocation information, where each piece of maximum transmission power allocation information is used for indicating a group of P1 and/or P2.

In an implementation, adjusting the transmission power of the one or more carriers of the N1 carriers includes:
adjusting a transmission power sequentially based on a priority order from low to high of services to be transmitted on the N1 carriers, until a sum of transmission powers of the N1 carriers after adjustment is less than or equal to P1; or,
adjusting, based on a transmission power adjustment weight of each of the N1 carriers, the transmission power of each of the carriers.

In an implementation, adjusting the transmission power of the one or more carriers of the N2 carriers includes:
adjusting a transmission power sequentially based on a priority order from low to high of services to be transmitted on the N2 carriers, until a sum of transmission powers of the N2 carriers after adjustment is less than or equal to P2; or,
adjusting, based on a transmission power adjustment weight of each of the N2 carriers, the transmission power of each of the carriers.

In a fourth aspect, the present disclosure provides a communication apparatus, being applied to a first terminal device, where the apparatus includes:
a processing module, configured to, when a sum of transmission powers of N carriers is greater than a maximum transmission power of the first terminal device, adjust a transmission power sequentially based on a priority order from low to high of services to be transmitted on the N carriers, until a sum of transmission powers of the N carriers after adjustment is less than or equal to the maximum transmission power, where carriers, out of the N carriers, for corresponding services having a same priority are subjected to transmission power adjustment based on a first adjustment order, the first adjustment order is related to a type of a channel/signal to be transmitted on the carriers for the corresponding services having the same priority; some or all of the N carriers are used for communication with a second terminal device; and N is an integer greater than or equal to 2; and
a transmitting module, configured to perform, with use of adjusted respective transmission powers of M carriers, channel/signal transmission simultaneously on the M carriers, where the M carriers are carriers, subjected to transmission power adjustment out of the N carriers, with transmission powers not being 0, and M is an integer greater than 0 and less than or equal to N.

In a fifth aspect, the present disclosure provides a communication apparatus, being applied to a first terminal device, where the apparatus includes:
a processing module, configured to, when a sum of transmission powers of N carriers is greater than a maximum transmission power of the first terminal device, adjust a transmission power of each of the carriers based on a transmission power adjustment weight of each of the carriers, so that a sum of transmission powers of the N carriers after adjustment is less than or equal to the maximum transmission power, where N is an integer greater than or equal to 2; and
a transmitting module, configured to perform, with use of adjusted respective transmission powers of M carriers, channel/signal transmission simultaneously on the M carriers, where the M carriers are carriers, subjected to transmission power adjustment out of the N carriers, with transmission powers not being 0, and M is an integer greater than 0 and less than or equal to N.

In a sixth aspect, the present disclosure provides a communication apparatus being applied to a first terminal device, where the apparatus includes:
a first processing module, configured to, when a sum of transmission powers of N1 carriers is greater than P1, adjust a transmission power of one or more carriers of the N1 carriers, so that a sum of transmission powers of the N1 carriers after adjustment is less than or equal to P1, where all of the N1 carriers are carriers used for transmitting first information, and the first information is used to feedback data reception status of the terminal device; P1 is a maximum transmission power allocated, from a maximum transmission power P of the first terminal device, to the N1 carriers; and N1 is an integer greater than or equal to 1; and
a first transmitting module, configured to transmit simultaneously, with use of adjusted respective transmission powers of M1 carriers, the first information on the M1 carriers, where the M1 carriers are carriers, subjected to transmission power adjustment out of the N1 carriers, with transmission powers not being 0, and M1 is an integer greater than 0 and less than or equal to N1;
and/or,
a second processing module, configured to, when a sum of transmission powers of N2 carriers is greater than P2, adjust a transmission power of one or more carriers of the N2 carriers, so that a sum of transmission powers of the N2 carriers after adjustment is less than or equal to P2, where all of the N2 carriers are used for transmitting information other than the first information; P2 is a maximum transmission power allocated, from the maximum transmission power P of the first terminal device, to the N2 carriers, and N2 is an integer greater than or equal to 1; and a sum of P1 and P2 is equal to P, or, under a circumstance that a first power is less than P1, P2 is a difference between P and the first power, where the first power is a sum of transmission powers of the N1 carriers; and
a second transmitting module, configured to transmit simultaneously, with use of adjusted respective transmission powers of M2 carriers, information other than the first information on the M2 carriers, where the M2 carriers are carriers, subjected to transmission power adjustment out of the N2 carriers, with transmission powers not being 0, and M2 is an integer greater than 0 and less than or equal to N2.

In a seventh aspect, the present disclosure provides a communication apparatus, including: a processor and a memory;
where the memory is configured to store computer executable program codes including instructions; and when the processor executes the instructions, the instructions enable the communication apparatus to implement the method according to any item of the first aspect, any item of the second aspect, or any item of the third aspect.

In an eighth aspect, the present disclosure provides a communication system which includes: the communication apparatus according to the seventh aspect.

In a ninth aspect, the present disclosure provides a chip, storing thereon a computer program, where when the computer program is executed by the chip, the method according to any item of the first aspect, or any item of the second aspect, or any item of the third aspect is implemented.

In a tenth aspect, the present disclosure provides a computer readable storage medium, storing thereon a computer program, where the computer program is configured to, when being executed by a computer, implement the communication method according to any item of the first aspect, or any item of the second aspect, or any item of the third aspect.

In an eleventh aspect, the present disclosure provides a computer program product, including a computer program, where the computer program, when being executed by a computer, implements the method according to any item of the first aspect, or any item of the second aspect, or any item of the third aspect.

The communication method and apparatus, the storage medium, and the program product provided in the present disclosure can be adaptable to transmission power control in NR V2X.

Those skilled in the art may clearly understand, for the convenience and brevity of description, the specific working process of a system, a device, and a unit described above may refer to the corresponding process in the foregoing method embodiments, which will not be repeated here.

The above description represents simply specific embodiments of the present disclosure, however, the protection scope of the present disclosure is not limited thereto, any modification or substitution, easily made by those ordinarily skilled in the art based on the technical scope disclosed by the present disclosure, shall be encompassed within the protection scope of the present disclosure. Therefore, the protection scope of the present disclosure shall be subject to the protection scope of the claims.

Finally, it should be noted that the above embodiments are merely used to explain the technical solutions of the present disclosure, but are not intended to limit the present disclosure. Although the present disclosure has been described in detail with reference to the foregoing embodiments, those ordinary skilled in the art should understand that modifications can be made to the technical solutions recorded in the foregoing embodiments, or some or all of the technical features thereof may be substituted by their equivalents, and such modifications or substitutions do not cause the nature of the corresponding technical solutions to deviate from the scope of the technical solutions of the embodiments of the present disclosure.

1. A communication method, being applied to a first terminal device, wherein the method comprises:
in case of a sum of transmission powers of N carriers is greater than a maximum transmission power of the first terminal device, adjusting a transmission power sequentially based on a priority order from low to high of services to be transmitted on the N carriers, until a sum of transmission powers of the N carriers after adjustment is less than or equal to the maximum transmission power, wherein carriers, out of the N carriers, for corresponding services having a same priority are subjected to transmission power adjustment based on a first adjustment order, the first adjustment order is related to a type of a channel/signal to be transmitted on the carriers for the corresponding services having the same priority; some or all of the N carriers are used for communication with a second terminal device; and N is an integer greater than or equal to 2; and
performing, with use of adjusted respective transmission powers of M carriers, channel/signal transmission on the M carriers simultaneously, wherein the M carriers are carriers, subjected to transmission power adjustment out of the N carriers, with transmission powers not being 0, and M is an integer greater than 0 and less than or equal to N.

2. The method according to claim 1, wherein the first adjustment order is predefined.

3. The method according to claim 1, further comprising:
receiving, from a network device, indication information which is used for indicating the first adjustment order; or,
receiving, from the network device, indication information which is used for indicating at least one adjustment order, wherein the at least one adjustment order comprises the first adjustment order.

4. The method according to claim 1, wherein adjusting the transmission power comprises:
reducing a transmission power of a carrier; or,
discarding a service to be transmitted on the carrier; or,
after reducing the transmission power of the carrier, in case of the sum of the transmission powers of the N carriers is still greater than the maximum transmission power, discarding the service to be transmitted on the carrier.

5. The method according to claim 1, wherein the N carriers comprise X carriers for channel/signal transmission of a service of a first network type, and Y carriers for channel/signal transmission of a service of a second network type; wherein X and Y are both positive integers, and a sum of X and Y is equal to N; the method further comprises:
receiving configuration information, wherein the configuration information is used for configuring priorities of the service of the first network type and the service of the second network type; or
determining the priorities of the service of the first network type and the service of the second network type independently.

6. The method according to claim 1, wherein the priorities of the service of the first network type and the service of the second network type are predefined.

7. The method according to claim 1, wherein the N carriers comprise a carrier for transmitting first information, wherein the first information is used to feedback data reception status of the first terminal device.

8-23. (canceled)

24. A communication apparatus, comprising: a processor and a memory;
wherein the memory is configured to store computer executable program codes comprising instructions; and when the processor executes the instructions, the instructions enable the communication apparatus to:
in case of a sum of transmission powers of N carriers is greater than a maximum transmission power of the first terminal device, adjust a transmission power sequentially based on a priority order from low to high of services to be transmitted on the N carriers, until a sum of transmission powers of the N carriers after adjustment is less than or equal to the maximum transmission power, wherein carriers, out of the N carriers, for corresponding services having a same priority are subjected to transmission power adjustment based on a first adjustment order, the first adjustment order is related to a type of a channel/signal to be transmitted on the carriers for the corresponding services having the same priority, some or all of the N carriers are used for communication with a second terminal device; and N is an integer greater than or equal to 2, and
perform, with use of adjusted respective transmission powers of M carriers, channel/signal transmission on the M carriers simultaneously, wherein the M carriers are carriers, subjected to transmission power adjustment out of the N carriers, with transmission powers not being 0, and M is an integer greater than 0 and less than or equal to N.

25. (canceled)

26. A non-transitory computer readable storage medium, storing thereon a computer program, wherein the computer program is configured to, when being executed by a computer, cause the computer to:
in case of a sum of transmission powers of N carriers is greater than a maximum transmission power of the first terminal device, adjust a transmission power sequentially based on a priority order from low to high of services to be transmitted on the N carriers, until a sum of transmission powers of the N carriers after adjustment is less than or equal to the maximum transmission power, wherein carriers, out of the N carriers, for corresponding services having a same priority are subjected to transmission power adjustment based on a first adjustment order, the first adjustment order is related to a type of a channel/signal to be transmitted on the carriers for the corresponding services having the same priority; some or all of the N carriers are used for communication with a second terminal device; and N is an integer greater than or equal to 2; and
perform, with use of adjusted respective transmission powers of M carriers, channel/signal transmission on the M carriers simultaneously, wherein the M carriers are carriers, subjected to transmission power adjustment out of the N carriers, with transmission powers not being 0, and M is an integer greater than 0 and less than or equal to N.

27. (canceled)

28. The apparatus according to claim 24, wherein the first adjustment order is predefined.

29. The apparatus according to claim 24, the instructions further enable the communication apparatus to:
receive, from a network device, indication information which is used for indicating the first adjustment order; or,
receive, from the network device, indication information which is used for indicating at least one adjustment order, wherein the at least one adjustment order comprises the first adjustment order.

30. The apparatus according to claim 24, wherein the instructions enable the communication apparatus to:
reduce a transmission power of a carrier; or,
discard a service to be transmitted on the carrier; or,
after reducing the transmission power of the carrier, in case of the sum of the transmission powers of the N carriers is still greater than the maximum transmission power, discard the service to be transmitted on the carrier.

31. The apparatus according to claim 24, wherein the N carriers comprise X carriers for channel/signal transmission of a service of a first network type, and Y carriers for channel/signal transmission of a service of a second network type; wherein X and Y are both positive integers, and a sum of X and Y is equal to N; the instructions further enable the communication apparatus to:
receive configuration information, wherein the configuration information is used for configuring priorities of the service of the first network type and the service of the second network type; or
determine the priorities of the service of the first network type and the service of the second network type independently.

32. The apparatus according to claim 24, wherein the priorities of the service of the first network type and the service of the second network type are predefined.

33. The apparatus according to claim 24, wherein the N carriers comprise a carrier for transmitting first information, wherein the first information is used to feedback data reception status of the first terminal device.

34. The storage medium according to claim 26, wherein the first adjustment order is predefined.

35. The storage medium according to claim 26, wherein the computer program is further configured to cause the computer to:
receive, from a network device, indication information which is used for indicating the first adjustment order; or,
receive, from the network device, indication information which is used for indicating at least one adjustment order, wherein the at least one adjustment order comprises the first adjustment order.

36. The storage medium according to claim 26, wherein the computer program is configured to cause the computer to:
reduce a transmission power of a carrier; or,
discard a service to be transmitted on the carrier; or,
after reducing the transmission power of the carrier, in case of the sum of the transmission powers of the N carriers is still greater than the maximum transmission power, discard the service to be transmitted on the carrier.

37. The storage medium according to claim 26, wherein the N carriers comprise X carriers for channel/signal transmission of a service of a first network type, and Y carriers for channel/signal transmission of a service of a second network type; wherein X and Y are both positive integers, and a sum of X and Y is equal to N; the computer program is further configured to cause the computer to:
receive configuration information, wherein the configuration information is used for configuring priorities of the service of the first network type and the service of the second network type; or
determine the priorities of the service of the first network type and the service of the second network type independently.

38. The storage medium according to claim 26, wherein the priorities of the service of the first network type and the service of the second network type are predefined.
